(19) United States
(12) Patent Application Publication
(10) Pub. No.: US 2023/0265345 A1
(43) Pub. Date: Aug. 24, 2023

(54) LIQUID CRYSTAL COMPOSITION CONTAINING POLYMERIZABLE COMPOUND AND APPLICATION OF LIQUID CRYSTAL COMPOSITION

(71) Applicant: BEIJING BAYI SPACE LCD TECHNOLOGY CO., LTD., Beijing (CN)

(72) Inventors: Yunpeng GUO, Beijing (CN); Maoxian CHEN, Beijing (CN); Chenghe LI, Beijing (CN); Jin YUAN, Beijing (CN); Jie REN, Beijing (CN); Youran LIU, Beijing (CN)

(21) Appl. No.: 17/906,685

(22) PCT Filed: Jun. 18, 2020
(86) PCT No.: PCT/CN2020/096707

§ 371 Date: Sep. 19, 2022

(30) Foreign Application Priority Data
Apr. 1, 2020 (CN) 202010251031.X

(51) Int. Cl. C09K 19/30

(52) U.S. Cl. CPC C09K 19/3003; C09K 19/3001; C09K 2019/0451

(57) ABSTRACT

A liquid crystal composition containing a polymerizable compound and an application of the liquid crystal composition. The liquid crystal composition comprises a nematic phase liquid crystal composition and at least contains one or more polymerizable compounds represented by general formula (I). Compared with existing liquid crystal compositions, the polymerizable compound in the liquid crystal composition has the advantages of faster polymerization rate, smaller pretilt angle change, higher conversion rate, and less residue, the problem that existing PSVA-type liquid crystal display is bad is mitigated to a large extent, the amount of pretilt angle change is reduced, and the area Mura problem is solved.

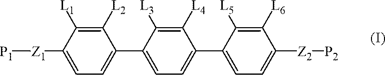

### CROSS-REFERENCES

This application claims the priority of Chinese patent application No. 202010251031.X entitled with “a liquid crystal composition containing polymerizable compound and use thereof” filed on Apr. 1, 2020, the entire disclosure of which is incorporated herein by reference in its entirety.

### TECHNICAL FIELD

The present invention belongs to the technical field of liquid crystal materials, and in particular relates to a liquid crystal composition containing a polymerizable compound and the use thereof.

### BACKGROUND ART

In recent years, liquid crystal display devices are widely used in various electronic devices, such as a smart phone, a tablet computer, an automotive navigator, and a television. Representative liquid crystal display modes include twisted nematic (TN) type, super twisted nematic (STN) type, in-plane switching (IPS) type, fringe-field switching (FFS) type and vertical alignment (VA) type. Among them, the VA mode has received more and more attention due to its fast falling time, high contrast ratio, wide viewing angle and high-quality images.

However, the liquid crystal medium used in a display element of the active matrix addressing type such as the VA mode has its own shortcomings, for example, the residual image level is significantly worse than that of a display element with positive dielectric anisotropy, the response time is relatively slow, and the driving voltage is relatively high.

A PSVA (polymer stabilized vertical alignment liquid crystal) type liquid crystal display element has a polymer structure formed in the liquid crystal cells to control the pretilt angle structure of liquid crystal molecules, and is used as a liquid crystal display element due to its high-speed response and high contrast ratio. A PSVA -type display element is manufactured by injecting a polymerizable composition comprising a liquid crystal compound and a polymerizable compound between substrates, irradiating same by means of ultraviolet radiation and polymerizing the polymerizable compound when liquid crystal molecules are aligned. The polymerizable compound as the main material is of great significance, and when matched with a suitable liquid crystal composition, it can effectively improve the response speed and the contrast ratio and solve the problem of display residual images.

The existing PSVA -type liquid crystal solves the above problems well, but still has other problems itself. The existing PSVA liquid crystal display -type has to undergo two ultraviolet irradiation processes during the cell process; the first irradiation process is power-on irradiation and mainly functions during the pretilt angle forming process, and the second ultraviolet irradiation process intends to consume unreacted RM monomers, improve the liquid crystal quality, and reduce RM residues. In the second ultraviolet irradiation process, the pretilt angle will continue to change, and the pretilt angles at different positions of the liquid crystal screen will have varying degrees of difference caused by the influence of temperature, thus bringing the area Mura problem. In order to solve the area Mura problem, reducing the pretilt angle change during the two ultraviolet irradiation processes is now an important issue in the research and development of the PSVA liquid crystals.

### SUMMARY OF THE INVENTION

A first objective of the invention is to provide a liquid crystal composition containing a polymerizable compound. Compared with existing liquid crystal compositions, the polymerizable compound in the liquid crystal composition of the present invention has the advantages of faster polymerization rate, smaller pretilt angle change, higher conversion rate, and less residue, the problem that existing PSVA-type liquid crystal display is bad is mitigated to a large extent, the amount of pretilt angle change is reduced, and the area Mura problem is solved.

Specifically, the liquid crystal composition provided by the present invention includes a nematic phase liquid crystal composition and at least contains one or more polymerizable compounds represented by general formula I:

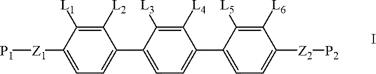

wherein L1, L2, L3, L4, L5, and L6 each independently represent H, —F, —Cl, —CH3, —C2H5, —OCH3, —OC2H5, —CF3 or OCF3, and L3 and L4 are not both H, and at least one of L1, L2, L5, and L6 is —CH3 or —OCH3;
the P1 and P2 each independently represent an acrylate group, a methacrylate group, a fluoroacrylate group, a chloroacrylate group, an ethyleneoxy group, an oxetanyl group, or an epoxy group;
the Z1 and Z2 each independently represent a single bond, —O—, —S—, —CO—, —CO—O—, —O—CO—, —O—CO—O—, —CH═N—, —N═CH—, —N═N—, a C1-C12 alkylene group, or a C2-C12 alkenyl group, wherein one or more hydrogen atoms in the C1-C12 alkylene group or the C2-C12 alkenyl group may each independently be substituted by F, Cl or CN, and one or more non-adjacent —CH2— groups may each independently be replaced by—O—, —S—, —NH—, —CO—, COO—, —OCO—, —OCOO—, —SCO—, —COS— or —C═C— in a way that is not directly connected to each other.

During the experiment, the technicians found that the liquid crystals are poured into a liquid crystal screen in a vacuum environment, and subjected to two periods of ultraviolet irradiations; in the first UV1 irradiation process, the initial pretilt angle is formed, and the second UV2 irradiation process mainly intends to treat unreacted polymerizable compounds; however, in the UV2 process, the pretilt angle of the liquid crystal cell continues to change, and the UV2 changes differently at different temperatures.

During the experiment, it was further found that different RM monomer structures have pretilt angles that change differently after two periods of ultraviolet irradiations,and after the RM monomers of two structures as shown below are mixed into a nematic phase liquid crystal and poured into a liquid crystal screen, the pretilt angles after two periods of ultraviolet irradiations change significantly. The RM-1 has a pretilt angle of 2.5° after the UV1 ultraviolet irradiation, and a pretilt angle of 2.1° after the UV2 ultraviolet irradiation, and the pretilt angle change is 0.4; the RM-2 has a pretilt angle of 2.5° after the UV1 ultraviolet irradiation, and a pretilt angle of 2.0° after the UV2 ultraviolet irradiation, and the pretilt angle change is 0.5.

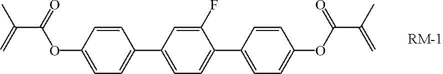 [SMILES: C=C(C)C(=O)Oc1ccc(-c2ccc(-c3ccc(OC(=O)C(=C)C)cc3)c(F)c2)cc1]

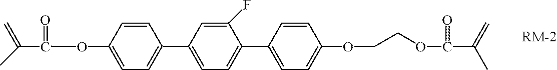 [SMILES: C=C(C)C(=O)OCCOc1ccc(-c2ccc(-c3ccc(OC(=O)C(=C)C)cc3)cc2F)cc1]

In addition, different temperatures will also have different effects on the pretilt angle change during the UV2 process. Therefore, during the UV2 ultraviolet irradiation process, due to the manufacture of the liquid crystal screen, there will be areas with uneven temperature, resulting in different pretilt angle in these areas, which in turn leads to the area Mura problem. It is found by the experiment that the greater the pretilt angle change from UV1 to UV2, the greater the effect of temperature during the UV2 process; and the smaller the pretilt angle change from UV1 to UV2, the smaller the effect of temperature during the UV2 process.

Further studies have confirmed that when the substituent at least one of the positions of L1, L2, L5, and L6 in the above-mentioned terphenyl polymerizable compound is —CH3 or —OCH3, the pretilt angle change of the polymerizable compound from UV1 to UV2 will be obviously reduced, thus effectively solving the area Mura problem. The liquid crystal composition added with a type I polymerizable compound can fully obtain the pretilt angle after being irradiated with ultraviolet light, and there is no obvious problem of return angle in areas with different temperatures during the UV2 process, thus effectively solving the area Mura problem caused by uneven area temperature during the UV2 process of liquid crystal screen production; Meanwhile, since the type I polymerizable compound has fast polymerization rate and less residue, there are no or few unreacted polymerizable compounds during the UV2 process, such that the undesirable conditions such as poor orientation and poor display will not occur, or such undesirable conditions can be fully suppressed.

In general formula I, preferably, L1, L2, L3, L4, L5, and L6 each independently represent H, —F, —CH3 or — OCH3, and L3 and L4 are not both H.

In general formula I, preferably, P1 and P2 each independently represent a methacrylate group, an acrylate group, a fluoroacrylate group or a chloroacrylate group; more preferably, P1 and P2 each independently represent a methacrylate group or an acrylate group.

In general formula I, preferably, Z1 and Z2 each independently represent a single bond, —O—, —S—, —CO—O—, —O—CO—, a C1-C6 alkylene group or a C2-C6 alkenyl group, wherein one or more hydrogen atoms in the C1-C6 alkylene group or the C2-C6 alkenyl group may each independently be substituted by F, and one or more non-adjacent —CH2— groups may each independently be replaced by—O— in a way that is not directly connected to each other; more preferably, Z1 and Z2 each independently represent a single bond, —O—, a C1-C6 alkylene group or an alkoxy group.

Specifically, the compound represented by general formula I provided by the present invention is selected from one or more of I1 - I28:

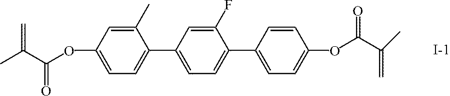

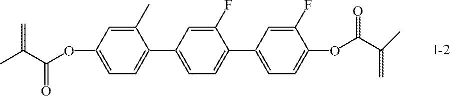

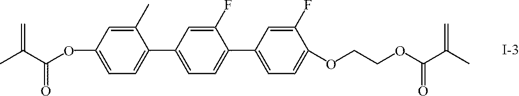

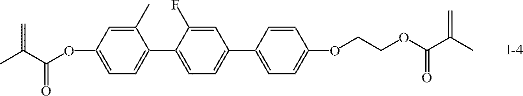

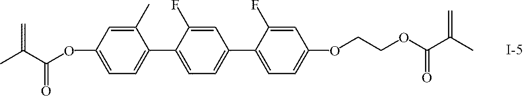

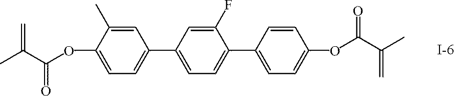

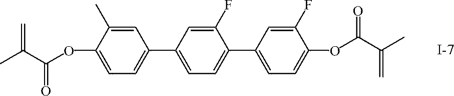

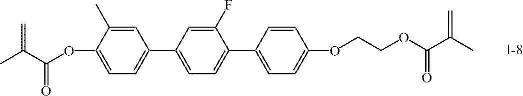

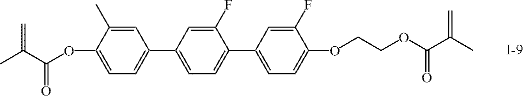

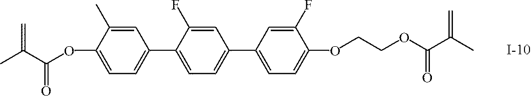

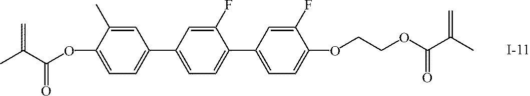

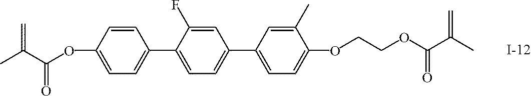

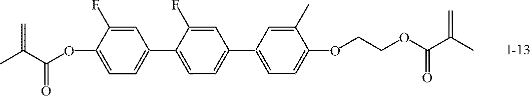

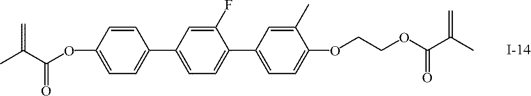

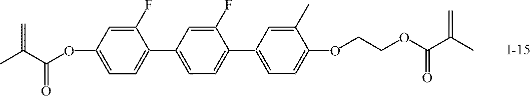

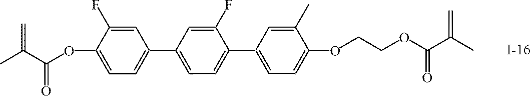

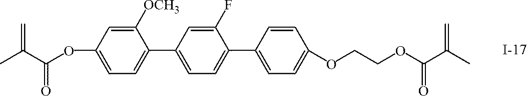

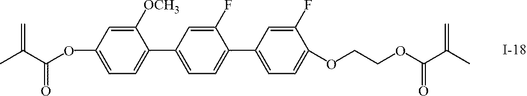

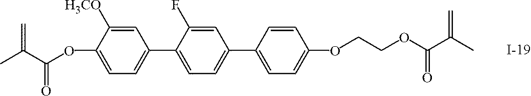

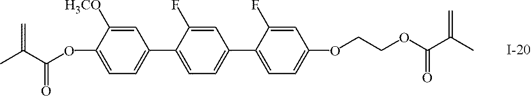

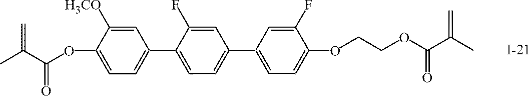

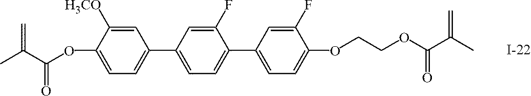

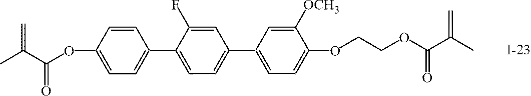

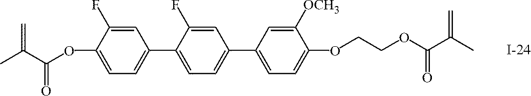

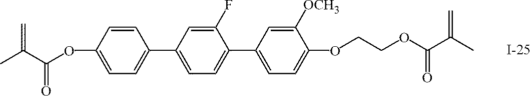

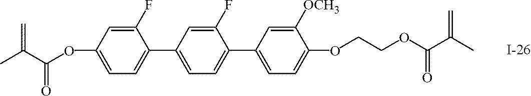

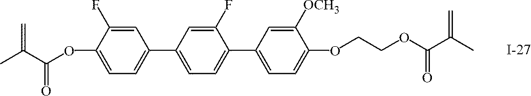

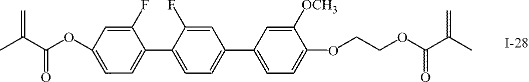

More preferably, the compound represented by general formula I provided by the present invention is selected from one or more of I1 - I5.

The polymerizable compound represented by general formula I in the liquid crystal composition provided by the present invention has a mass fraction of 0.01-5%, preferably 0.05-1%, further preferably 0.1-0.5%, and more preferably 0.15-0.32%.

Specifically, in the liquid crystal composition provided by the present invention, the nematic phase liquid crystal composition at least comprises one or more compounds represented by general formula II:

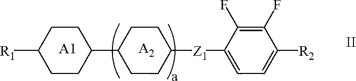

wherein R₁ and R₂ each independently represent a C₁-C₁₂ linear alkyl group, a linear alkoxy group or a C₂-C₁₂ linear alkenyl group, and A₁ and A₂ each independently represent a trans-1,4-cyclohexyl group or a 1,4-phenylene group; Z1 is a single bond, —CH₂CH₂₋ or —CH₂O—; a is 0 or 1;
and at least comprises a compound represented by general formula III:

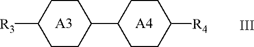

wherein R₃ and R₄ each independently represent a C₁-C₁₂ linear alkyl group, a linear alkoxy group or a C₂-C₁₂ linear alkenyl group, and A₃ and A₄ each independently represent a trans-1,4-cyclohexyl group or a 1,4-phenylene group.

Specifically, the compound represented by general formula II provided by the present invention is selected from one or more of IIA - IIF:

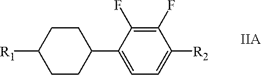

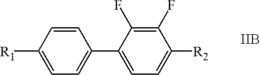

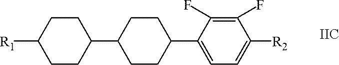

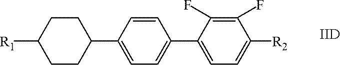

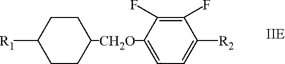

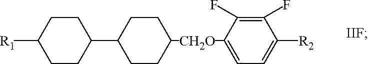

preferably, the compound represented by general formula II provided by the present invention is selected from one or more of formulas IIA-1 - IIF-16:

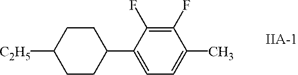

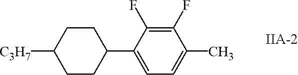

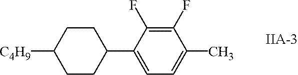

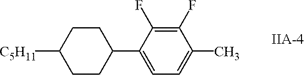

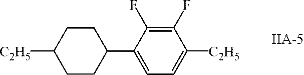

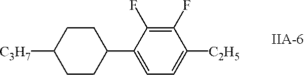

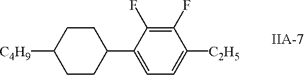

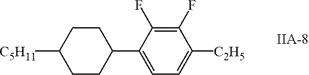

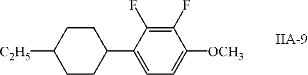

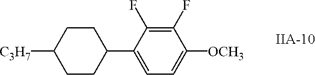

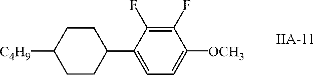

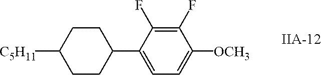

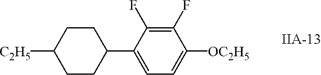

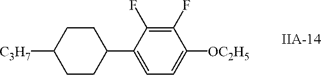

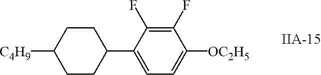

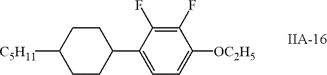

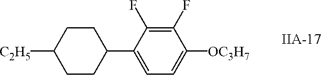

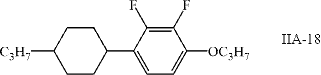

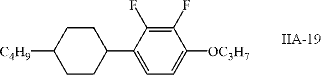

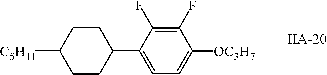

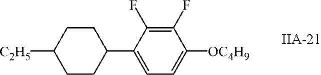

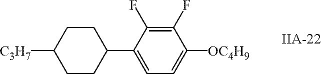

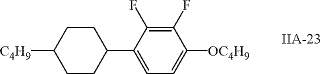

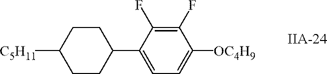

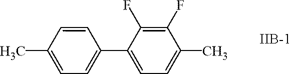

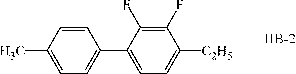

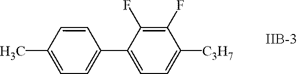

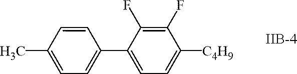

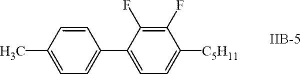

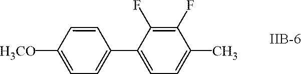

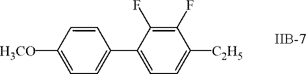

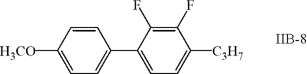

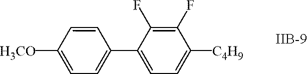

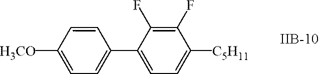

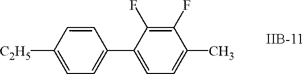

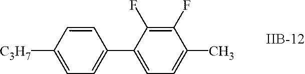

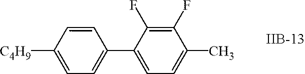

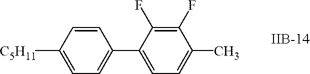

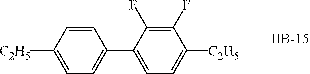

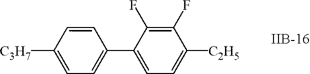

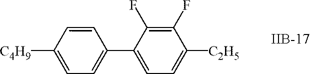

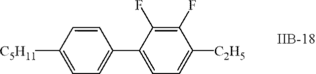

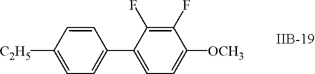

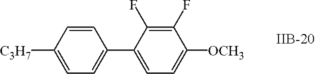

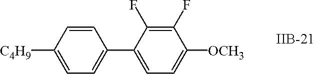

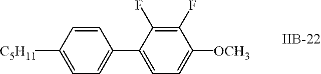

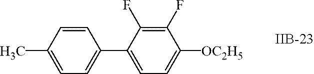

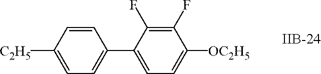

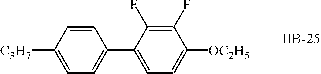

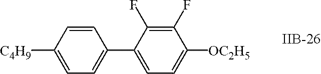

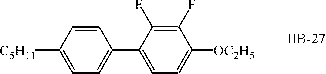

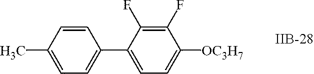

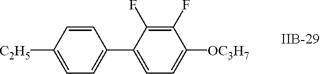

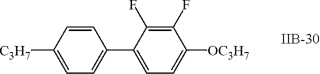

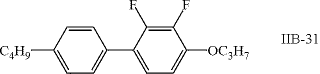

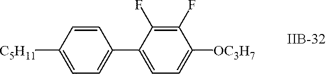

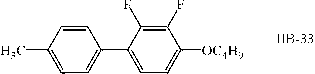

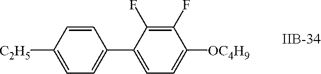

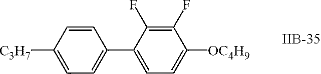

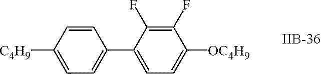

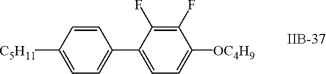

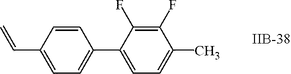

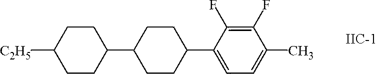

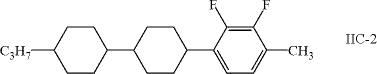

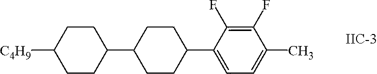

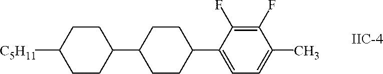

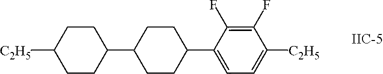

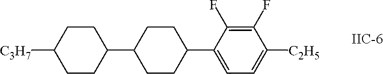

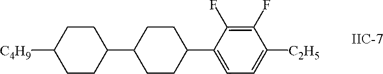

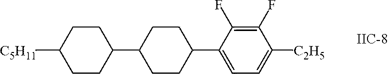

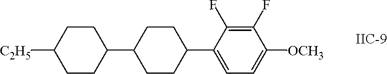

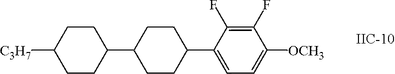

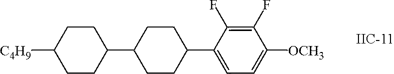

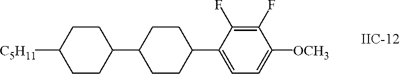

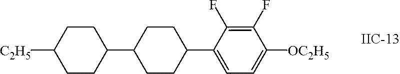

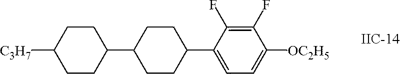

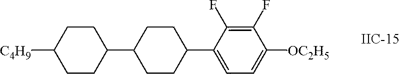

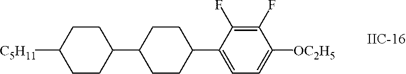

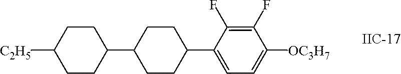

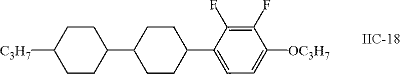

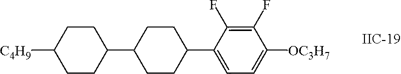

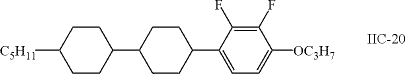

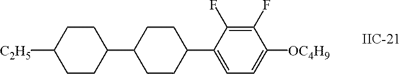

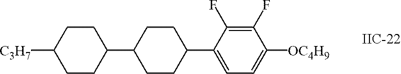

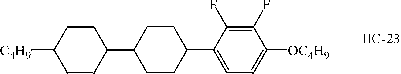

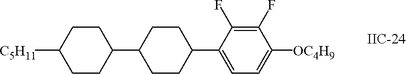

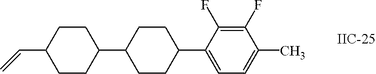

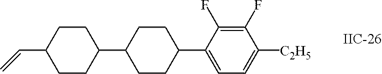

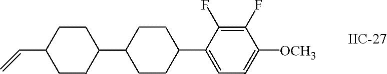

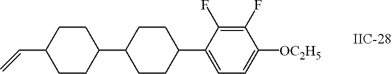

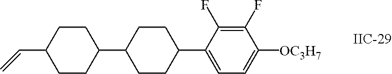

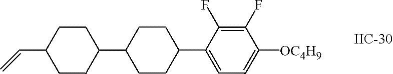

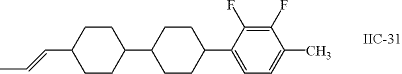

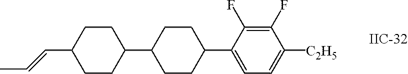

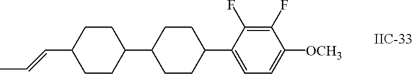

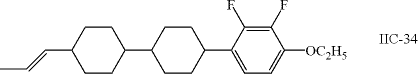

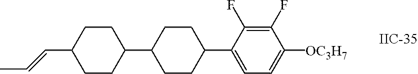

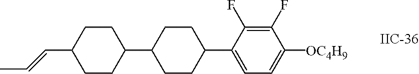

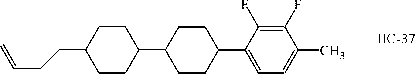

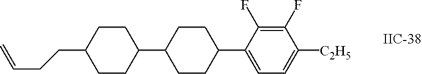

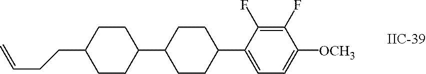

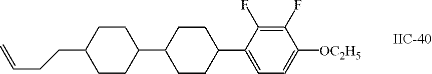

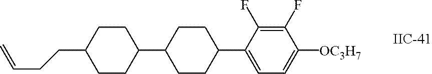

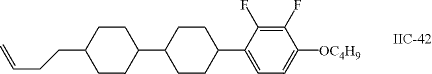

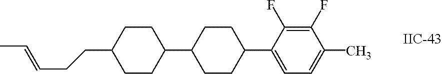

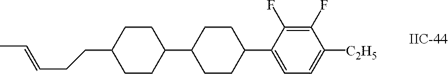

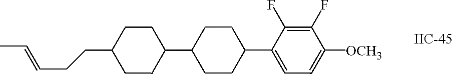

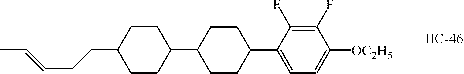

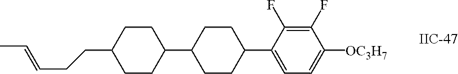

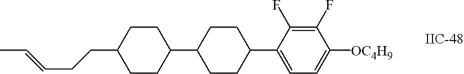

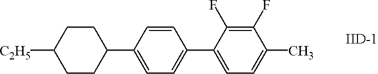

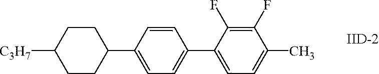

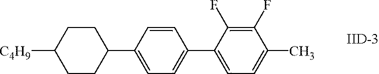

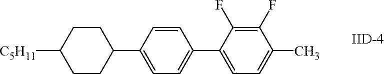

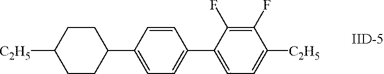

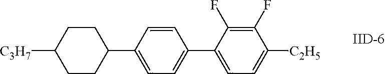

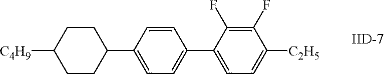

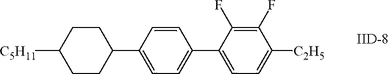

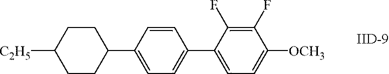

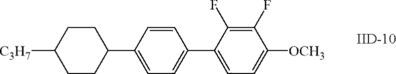

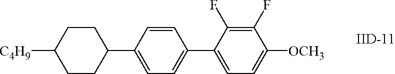

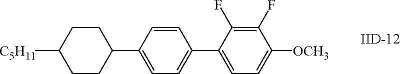

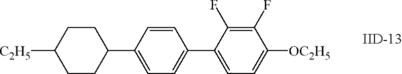

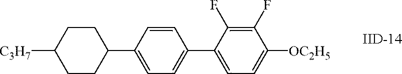

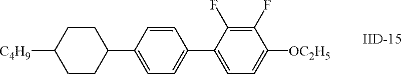

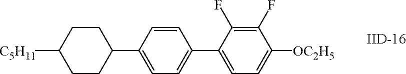

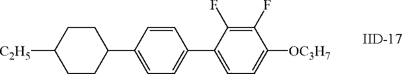

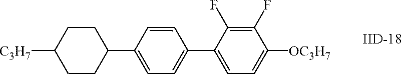

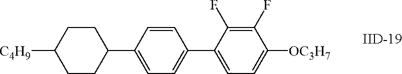

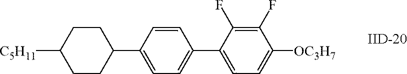

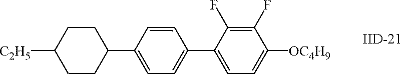

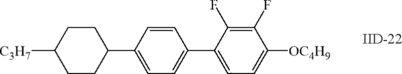

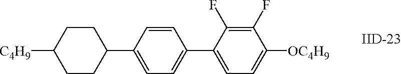

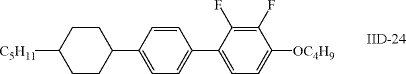

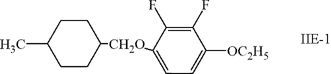

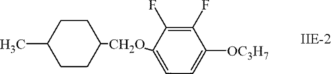

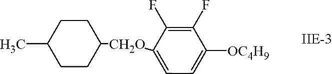

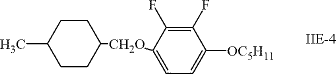

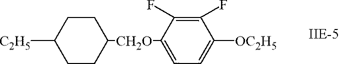

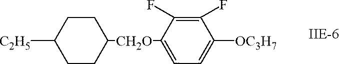

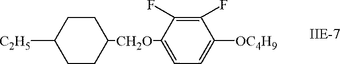

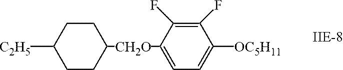

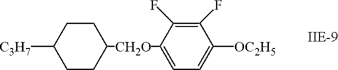

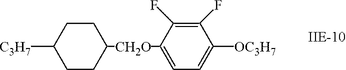

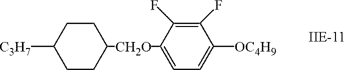

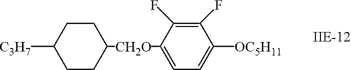

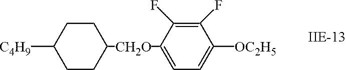

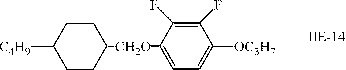

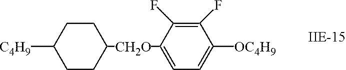

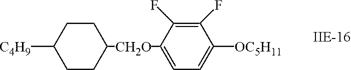

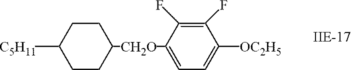

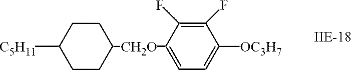

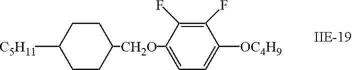

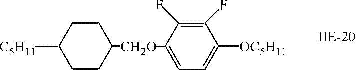

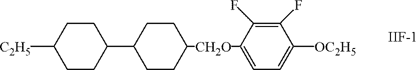

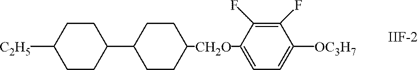

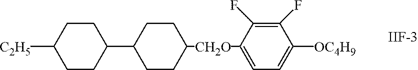

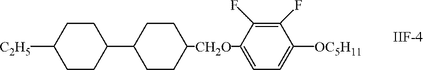

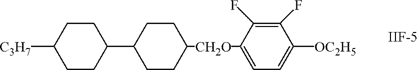

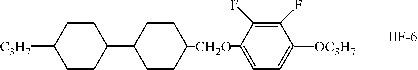

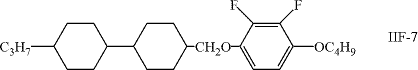

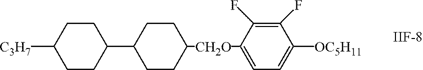

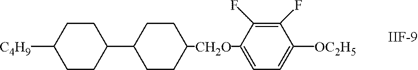

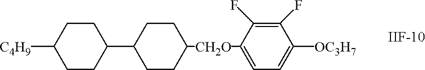

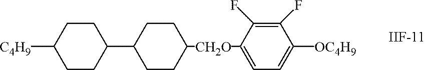

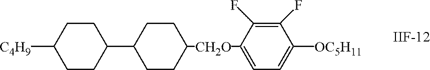

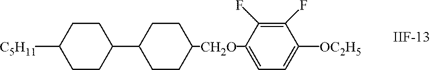

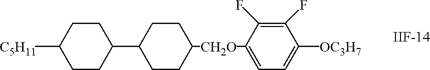

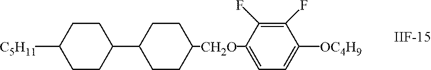

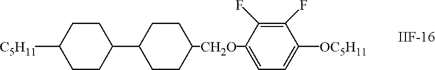

more preferably, the compound represented by general formula II provided by the present invention is selected from one or more of formulas IIA-9 - IIA-24, IIB-19 -IIB-38, IIC-9 - IIC-24, IID-9 - IID-24, IIE-1 - IIE-20, and IIF-1 - IIF-16;
most preferably, the compound represented by general formula II provided by the present application is selected from one or more of formulas IIA-13 - IIA-24, IIB-23 -IIB-38, IIC-13 - IIC-24, IID-13 - IID-24, IIE-1, IIE-2, IIE-5, IIE-6, IIE-9, IIE-10, IIE-13, IIE-14, IIE-17, IIE-18, IIF-1, IIF-2, IIF-5, IIF-6, IIF-9, IIF-10, IIF-13 and IIF-14;
specifically, the compound represented by general formula III of the present invention is selected from one or more of formulas IIIA - IIIC:

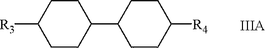

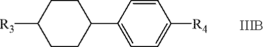

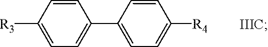

preferably, the compound represented by general formula III provided by the present invention is selected from one or more of formulas IIIA1 - IIIC24:

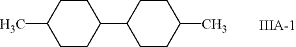

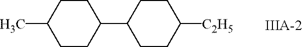

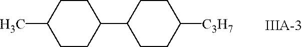

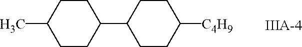

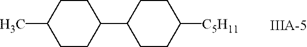

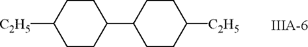

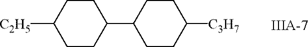

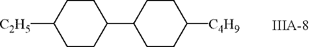

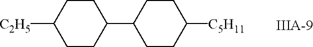

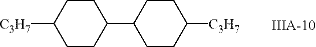

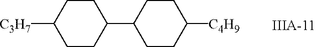

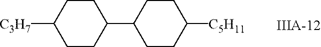

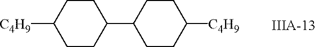

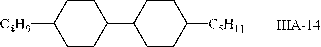

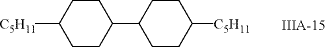

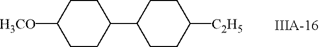

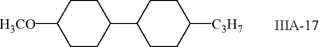

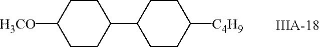

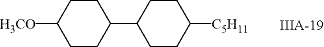

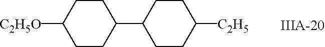

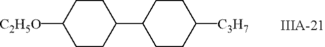

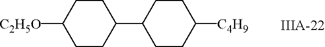

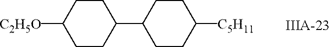

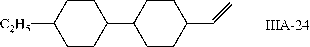

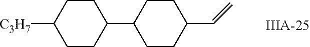

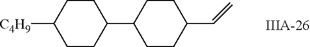

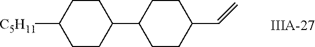

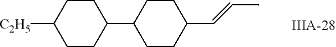

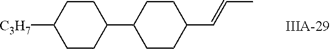

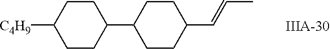

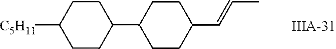

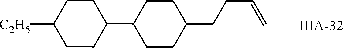

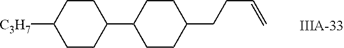

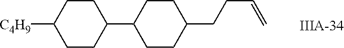

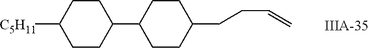

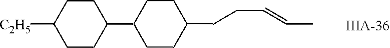

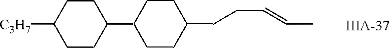

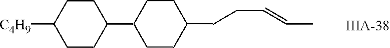

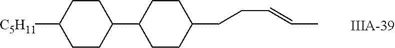

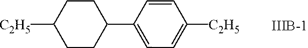

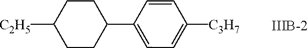

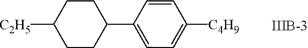

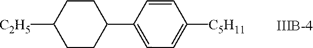

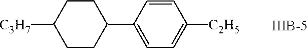

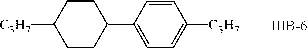

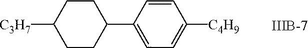

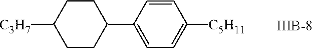

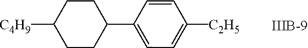

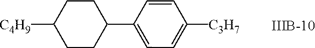

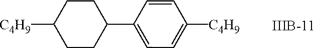

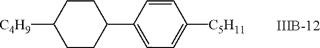

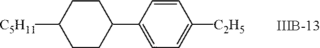

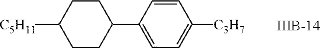

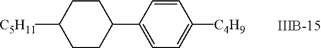

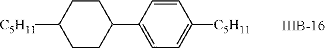

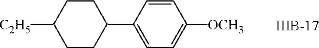

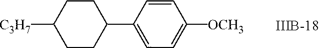

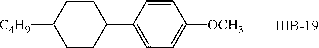

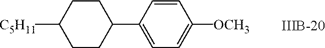

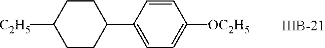

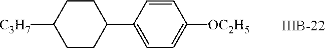

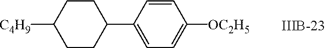

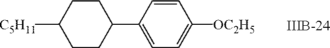

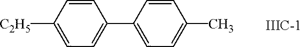

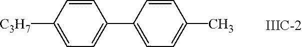

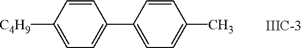

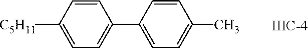

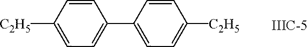

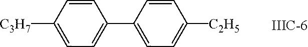

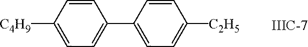

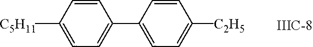

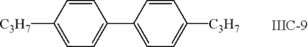

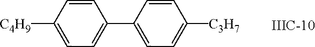

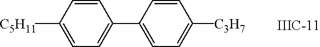

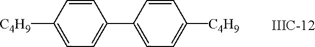

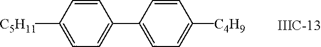

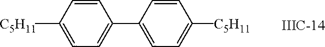

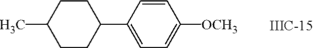

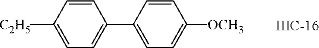

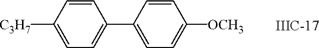

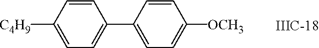

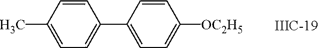

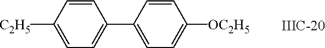

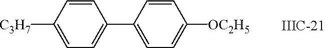

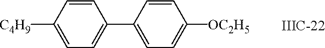

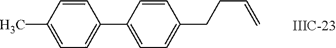

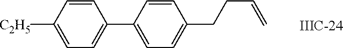

more preferably, the compound represented by general formula III provided by the present invention is selected from one or more of formulas IIIA-1 - IIIA-24, IIIB-1 -IIIB-24, and IIIC-1 - IIIC-22;
most preferably, the compound represented by general formula III provided by the present invention is selected from one or more of formulas IIIA-1 - IIIA-12, IIIB-17 -IIIB-24, IIIC-1 - IIIC-4, and IIIC-15 - IIIC-18.

The liquid crystal composition provided by the present invention may further comprise one or more compounds represented by general formula IV:

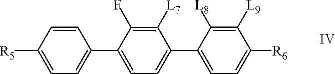

wherein R₅ and R₆ each independently represent a C₁-C₁₂linear alkyl group, a linear alkoxy group or a C₂-C₁₂ linear alkenyl group, or halogen. L7, L8, and L9 each independently represent —H, —F, —CH3 or —OCH3.

Specifically, the compound represented by general formula IV provided by the present invention is selected from one or more of IVA - IVD:

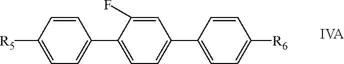

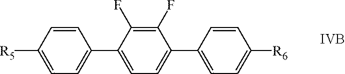

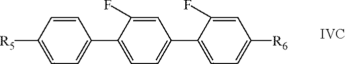

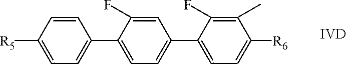

wherein R₅ and R₆ each independently represent a C₁-C₁₂ linear alkyl group, a linear alkoxy group, a C₂-C₁₂ linear alkenyl group or halogen.

Specifically, the compound represented by general formula IV provided by the present invention is selected from one or more of IVA1 - IVD24:

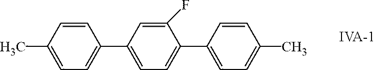

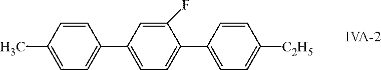

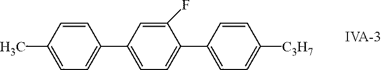

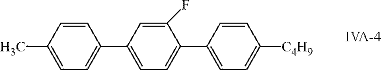

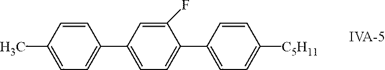

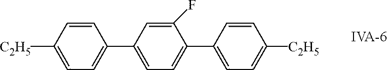

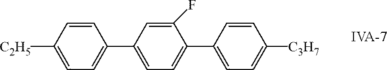

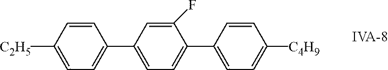

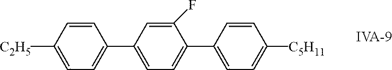

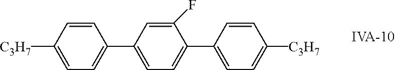

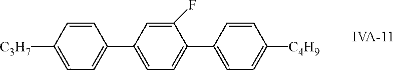

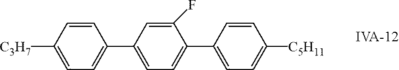

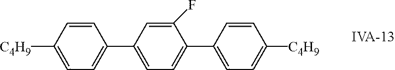

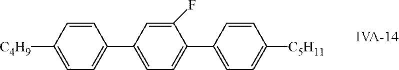

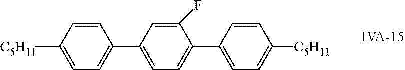

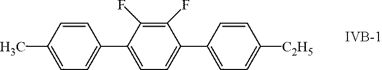

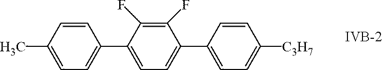

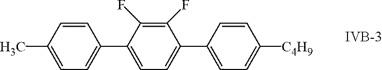

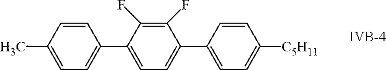

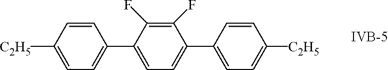

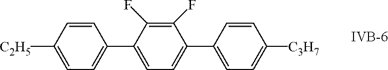

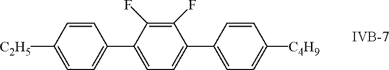

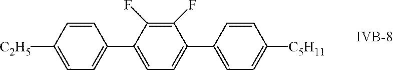

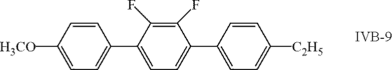

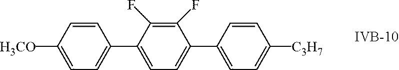

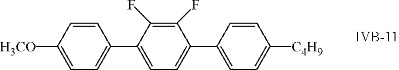

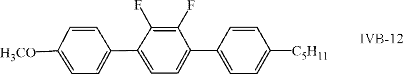

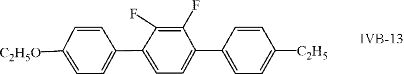

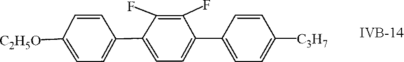

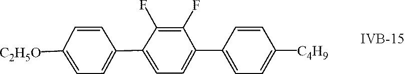

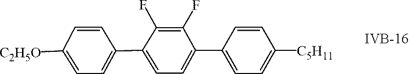

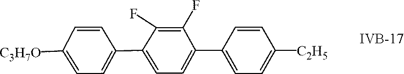

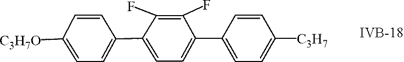

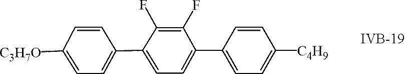

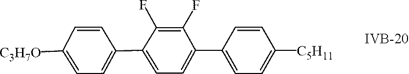

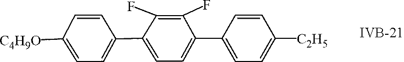

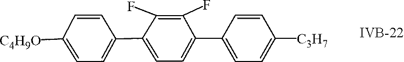

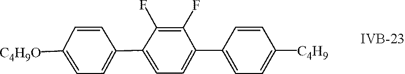

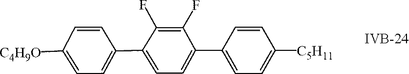

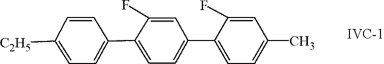

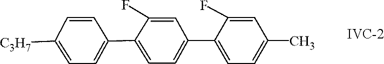

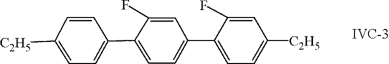

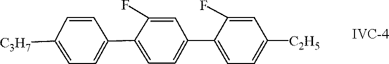

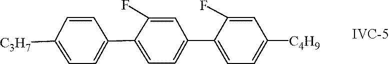

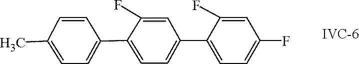

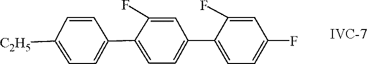

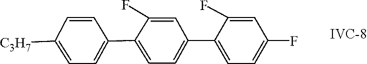

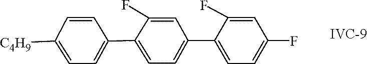

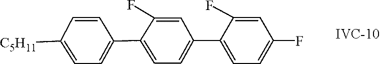

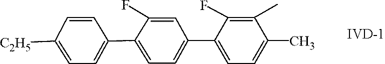

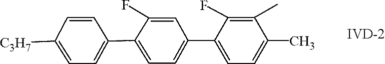

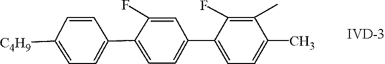

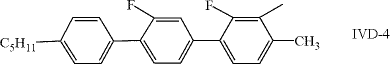

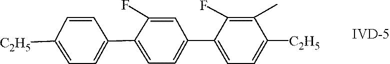

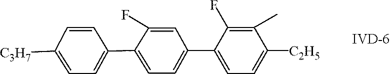

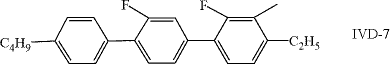

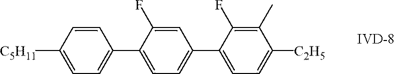

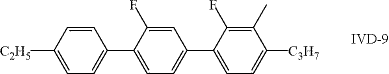

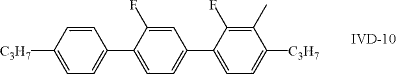

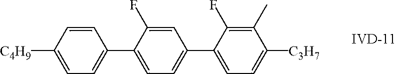

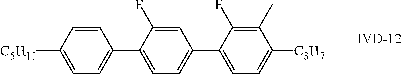

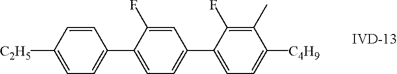

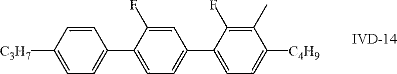

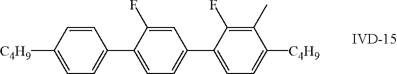

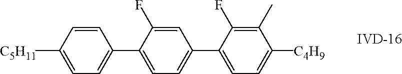

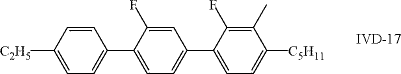

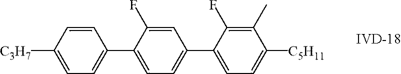

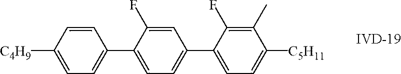

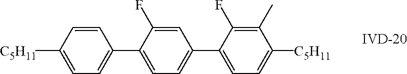

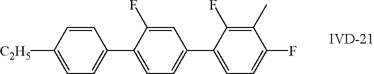

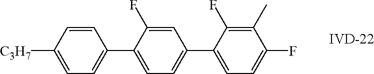

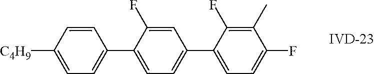

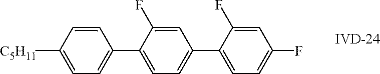

more preferably, the compound represented by general formula IV provided by the present invention is selected from one or more of IVA-5, IVA-9, IVA-14, IVA-15, IVB-5 - IVB-8, IVB-6 - IVB-10, and IVD-21 - IVD-24.

The liquid crystal composition provided by the present invention can further comprise one or more compounds represented by general formula V:

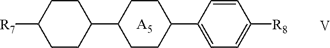

wherein R₇ and R₈ each independently represent a C₁-C₁₂ linear alkyl group, a linear alkoxy group or a C₂-C₁₂ linear alkenyl group; A₅ each independently represents a trans-1,4-cyclohexyl group or a 1,4-phenylene group.

Specifically, the compound represented by general formula V provided by the present invention is selected from one or more of VA - VB:

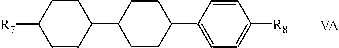

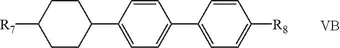

wherein R₇ and R₈ each independently represent a C₁-C₇ linear alkyl group, a linear alkoxy group or a C₂-C₇ linear alkenyl group.

Preferably, the compound represented by general formula V provided by the present invention is selected from one or more of VA1 - VB63:

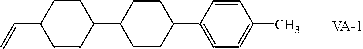

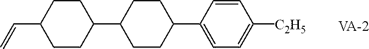

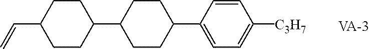

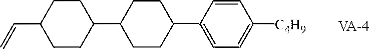

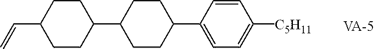

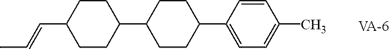

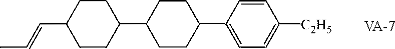

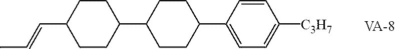

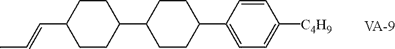

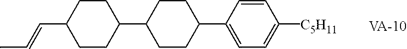

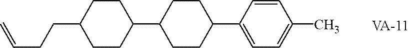

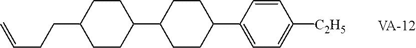

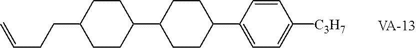

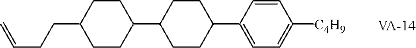

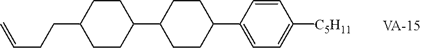

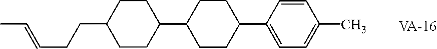

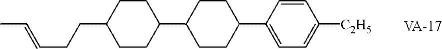

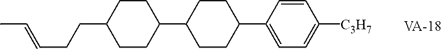

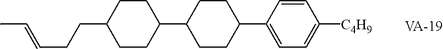

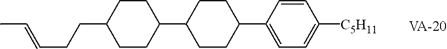

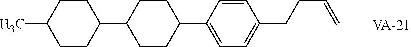

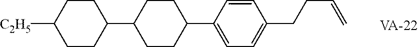

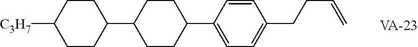

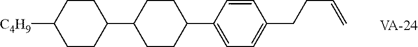

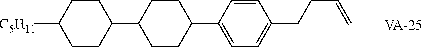

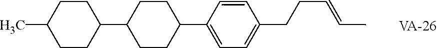

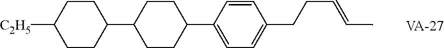

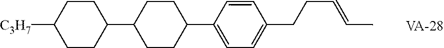

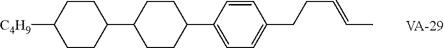

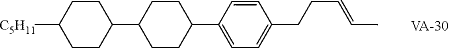

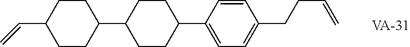

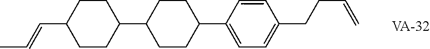

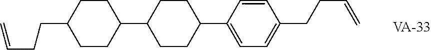

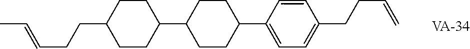

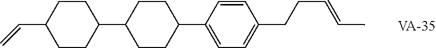

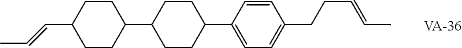

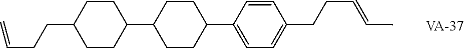

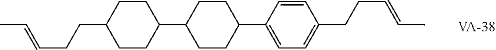

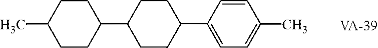

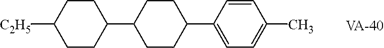

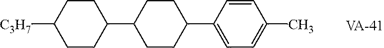

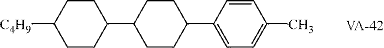

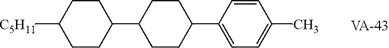

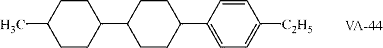

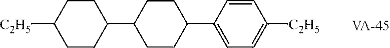

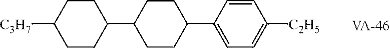

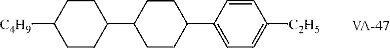

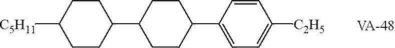

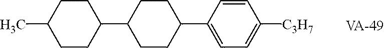

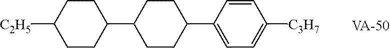

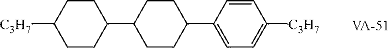

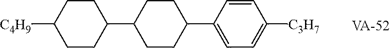

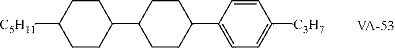

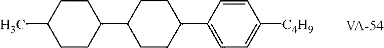

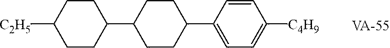

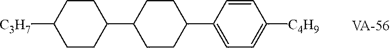

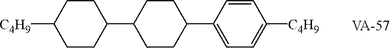

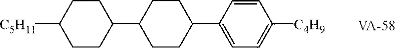

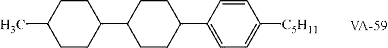

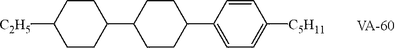

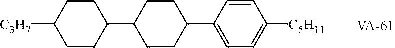

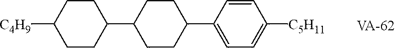

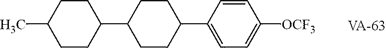

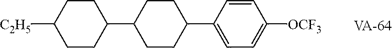

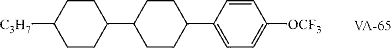

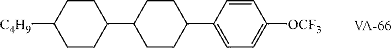

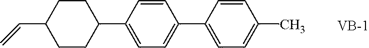

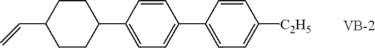

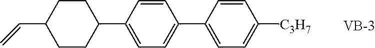

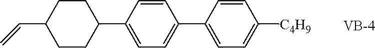

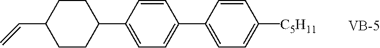

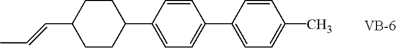

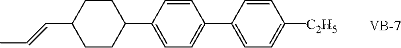

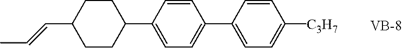

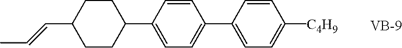

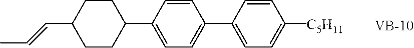

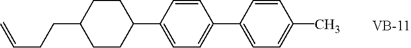

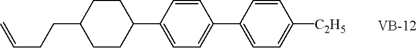

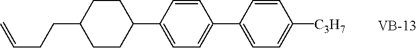

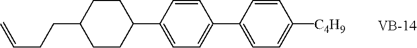

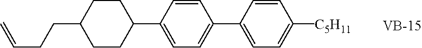

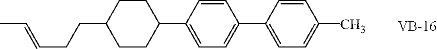

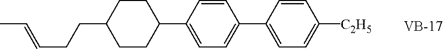

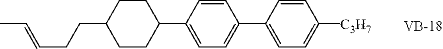

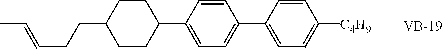

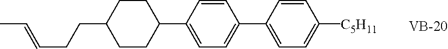

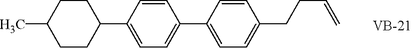

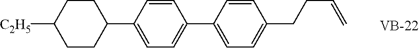

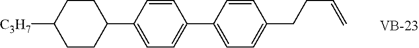

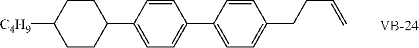

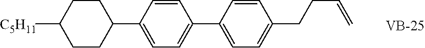

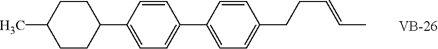

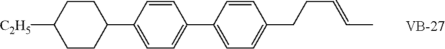

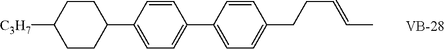

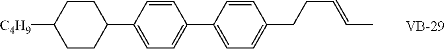

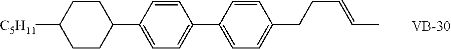

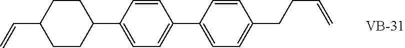

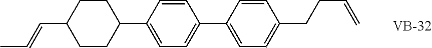

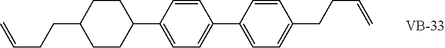

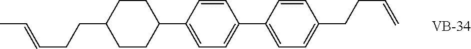

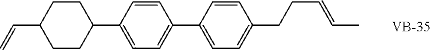

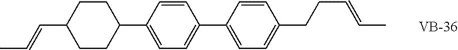

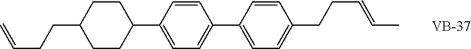

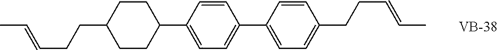

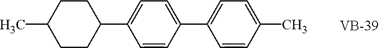

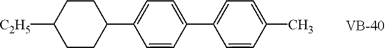

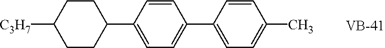

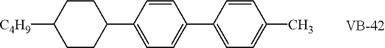

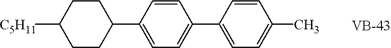

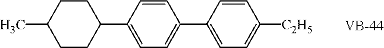

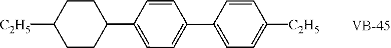

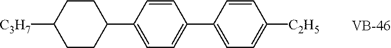

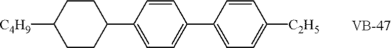

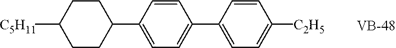

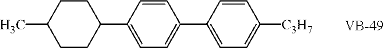

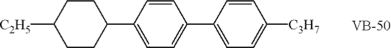

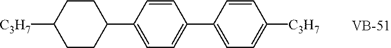

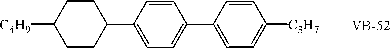

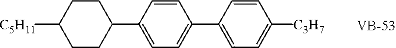

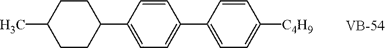

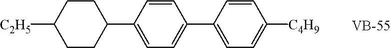

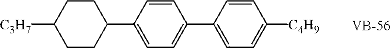

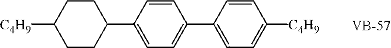

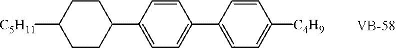

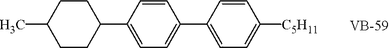

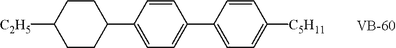

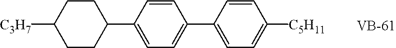

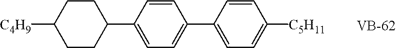

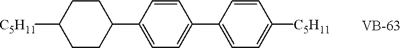

More preferably, the compound represented by general formula V provided by the present invention is selected from one or more of VA-39 - VA-44, and VB-39 -VB-48.

The liquid crystal composition provided by the present invention can further comprise one or more antioxidants represented by general formula VI:

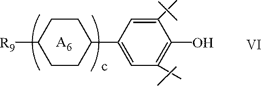

wherein R₉ each independently represents a C₁-C₇ linear alkyl group, a linear alkoxy group or a C₂-C₇ linear alkenyl group; A₆ each independently represents a trans-1,4-cyclohexyl group or a 1,4-phenylene group, and c is 0 or 1;
preferably, the compound represented by general formula VI provided by the present invention is selected from one or more of VI-1 - VI-2:

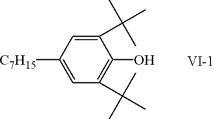

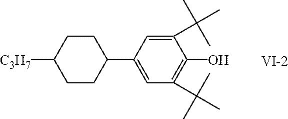

In addition to the above compounds, the liquid crystal composition of the present invention may comprise a common antioxidant, an ultraviolet absorber, a light stabilizer or a infrared absorber, etc.

In order to make the liquid crystal composition meet different needs, according to the mass percentage of the nematic phase liquid crystal components in the liquid crystal composition, the nematic phase liquid crystal composition provided by the present invention comprises the following components by mass percentage:
(1) 1-80% of the compound represented by general formula II;
(2) 1-70% of the compound represented by general formula III;
(3) 0-25% of the compound represented by general formula IV;
and (4) 0-25% of the compound represented by general formula V.

Preferably, the liquid crystal compound provided by the present invention comprises the following components by mass percentage:
(1) 5-70% of the compound represented by general formula II;
(2) 20-60% of the compound represented by general formula III;
(3) 0-15% of the compound represented by general formula IV;
and (4) 0-15% of the compound represented by general formula V.

More preferably, the liquid crystal compound provided by the present invention comprises the following components by mass percentage:
(1) 10-70% of the compound represented by general formula II;
(2) 25-60% of the compound represented by general formula III;
(3) 0-10% of the compound represented by general formula IV;
and (4) 0-10% of the compound represented by general formula V.

Particularly preferably, the liquid crystal compound provided by the present invention comprises the following components by mass percentage:
(1) 20-70% of the compound represented by general formula II;
(2) 20-50% of the compound represented by general formula III;
(3) 0-6% of the compound represented by general formula IV;
and (4) 0-9% of the compound represented by general formula V.

In the liquid crystal composition provided by the present invention, the polymerizable compound represented by general formula I is separately added in addition to the mass percentage of the nematic phase liquid crystal composition.

The method for producing the liquid crystal composition of the present invention is not particularly limited, and the liquid crystal composition may be produced by mixing two or more compounds using a conventional method, e.g., being prepared by a method of mixing and dissolving various components at a high temperature, wherein the liquid crystal composition is dissolved in a solvent used for the compounds and mixed, and then the solvent is distilled off under a reduced pressure; or the liquid crystal composition of the present invention may be prepared according to a conventional method, e.g., being obtained by dissolving components with lower contents therein into main components with higher contents at a higher temperature, or dissolving the various components in an organic solvent, such as acetone, chloroform or methanol, and then mixing the solution, followed by the removal of the solvent.

The present invention further provides the use of the above liquid crystal composition in a vertical alignment (VA) type liquid crystal display device, preferably in a PSVA-type liquid crystal display device.

### DETAILED DESCRIPTION OF EMBODIMENTS

The following examples are intended to illustrate the present invention, but not to limit the scope of the present invention.

Unless otherwise indicated, the percentage in the present invention is weight percentage; the temperature unit is degrees Celsius; Δn represents optical anisotropy (25° C.); ε_{//} and ε_{⊥} represent the parallel and vertical dielectric constants (25° C., 1000 Hz), respectively; Δ_{ε} represents dielectric anisotropy (25° C., 1000 Hz); γ1 represents rotational viscosity (mPa.s, 25° C.); Cp represents the clearing point (°C) of the liquid crystal composition; K₁₁, K₂₂ and K₃₃ represent splay, twist and bend elastic constants (pN, 25° C.), respectively. ρ represents resistivity (Ω·cm), and the test condition is 25 ± 2° C.

In each of the following examples, the group structures in the liquid crystal compound are represented by the codes shown in Table 1.

TABLE 1

Group structure code of the liquid crystal compound

| | | |
|---|---|---|
| Group | Code | Group name |
| 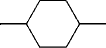 | C | 1,4-cyclohexyl |
| 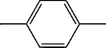 | P | 1,4-phenylene |
| 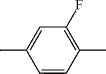 | G | 3-fluoro-1,4-phenylene |
| 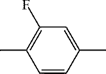 | D | 2-fluoro-1,4-phenylene |
| 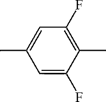 | U | 2,6-difluoro-1,4-phenylene |
| 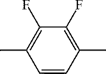 | W | 2,3-difluoro-1,4-phenylene |
| 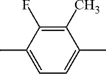 | K | 2,-fluoro-3,methyl-1,4-phenylen e |
| —O— | O | Oxygen substituent |
| —F | F | Fluorine substituent |
| —CF₃ | CF₃ | Trifluoromethyl |
| CₙH₂ₙ₊₁ or CₘH₂ₘ₊₁ | n or m | Alkyl |
| —CF₂O— | Q | Difluoromethoxy bridge bond |
| —OCF₂H | OCF₂H | Difluoromethoxy |
| 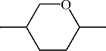 | A | 2,5-tetrahydropyran |
| 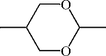 | E | 2,6-dioxo-1,4-dioxane |
| —(CH₂)ₙ— | n | Alkylene |
| 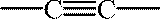 | T | Acetylenic bond |
| 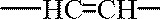 | V | Alkenyl |

Taking the following compound structures as an example:

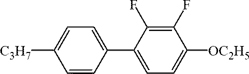

Represented as: 3PWO2

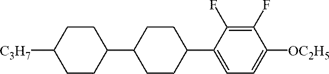

Represented as: 3CCWO2

In each of the following examples, the liquid crystal compositions are all prepared by a thermal dissolution method, comprising the following steps of: weighing liquid crystal compounds in percentage by weight using a balance, wherein the order of weighing and addition is not particularly specified, and usually, the weighing and mixing are carried out successively in order of the melting points of the liquid crystal compounds from high to low; heating and stirring same at 60-100° C. so that each component is melted uniformly; then subjecting same to filtration and rotary evaporation; and finally performing encapsulation to obtain a target sample.

The weight percentage of each component in the nematic phase liquid crystal composition and the performance parameters of the liquid crystal composition are shown in the following tables.

### Nematic Phase Liquid Crystal Composition LC1

TABLE 2

Percentages by weight of each component and performance parameters of the liquid crystal composition

| Category | Compound code | Percentage by weight (%) | Performance parameter | Parameter value |
|---|---|---|---|---|
| II | 2CPWO2 | 4 | Δn | 0.0985 |
| II | 3CPWO2 | 10 | ε_{//} | 3.6 |
| II | 2CC1OWO2 | 7 | ε_{⊥} | 6.9 |
| II | 3CC1OWO2 | 15 | Δε | -3.3 |
| II | 3C1OWO2 | 12 | Cp | 74.7 |
| III | 5PP1 | 11 | γ1 | 102.1 |
| III | 3CPO2 | 5 | K₁₁ | 15.2 |
| III | 5CC3 | 18 | K₂₂ | 7.6 |
| III | 4CC3 | 7 | K₃₃ | 15.0 |
| III | 3CC2 | 6 | | |
| V | 3CPP2 | 5 | | |

### Nematic Phase Liquid Crystal Composition LC2

TABLE 3

Percentages by weight of each component and performance parameters of the liquid crystal composition

| Category | Compound code | Percentage by weight (%) | Performance parameter | Parameter value |
|---|---|---|---|---|
| II | 3CCWO3 | 7 | Δn | 0.0965 |
| II | 3CWO2 | 14 | ε_{//} | 3.6 |
| II | 3CCWO2 | 10 | ε_{⊥} | 6.9 |
| II | 3PWO2 | 10 | Δε | -3.3 |
| II | 3CCWO1 | 8 | Cp | 77.4 |
| II | 4PWO2 | 6.5 | γ1 | 5.8 |
| III | 3CC1V1 | 8 | K₁₁ | 14.3 |
| III | 5CC3 | 10.5 | K₂₂ | 7.2 |
| III | 4CC3 | 6 | K₃₃ | 15.6 |
| III | 3CC2 | 6 | | |
| IV | 2PWP1 | 5 | | |
| V | 3CCP1 | 9 | | |

### Nematic Phase Liquid Crystal Composition LC3

TABLE 4

Percentages by weight of each component and performance parameters of the liquid crystal composition

| Category | Compound code | Percentage by weight (%) | Performance parameter | Parameter value |
|---|---|---|---|---|
| II | 2CPWO2 | 4 | Δn | 0.1002 |
| II | 3CPWO2 | 10.5 | ε_{//} | 3.6 |
| II | 2CC1OWO2 | 7 | ε_{⊥} | 6.9 |
| II | 3CC1OWO2 | 15 | Δε | -3.3 |
| II | 3C1OWO2 | 12 | Cp | 75 |
| III | 5PP1 | 15 | γ1 | 97.9 |
| III | 3CPO2 | 4 | K₁₁ | 15.1 |
| III | 5CC3 | 18.5 | K₂₂ | 7.6 |
| III | 4CC3 | 6 | K₃₃ | 15.4 |
| V | 3CCP1 | 8 | | |

### Nematic Phase Liquid Crystal Composition LC4

TABLE 5

Percentages by weight of each component and performance parameters of the liquid crystal composition

| Category | Compound code | Percentage by weight (%) | Performance parameter | Parameter value |
|---|---|---|---|---|
| II | 2CPWO2 | 4 | Δn | 0.1090 |
| II | 3CPWO2 | 10 | ε_{//} | 3.6 |
| II | 2CC1OWO2 | 8 | ε_{⊥} | 3.9 |
| II | 3CC1OWO2 | 15 | Δε | -3.3 |
| II | 3C1OWO2 | 11 | Cp | 76 |
| III | 3PP1 | 15 | γ1 | 99 |
| III | 3CPO2 | 4 | K₁₁ | 15.0 |
| III | 5CC3 | 18.5 | K₂₂ | 7.5 |
| III | 4CC3 | 6 | K₃₃ | 15.4 |
| V | 3CPP1 | 8.5 | | |

### Nematic Phase Liquid Crystal Composition LC5

TABLE 6

Percentages by weight of each component and performance parameters of the liquid crystal composition

| Category | Compound code | Percentage by weight (%) | Performance parameter | Parameter value |
|---|---|---|---|---|
| II | 2CPWO2 | 7 | Δn | 0.1080 |
| II | 3CPWO2 | 10 | ε_{//} | 3.2 |
| II | 3CCWO2 | 5 | ε_{⊥} | 4.1 |
| II | 2CC1OWO2 | 7 | Δε | -3.9 |
| II | 3CC1OWO2 | 15 | Cp | 72 |
| II | 2C1OWO2 | 1 | γ1 | 95 |
| II | 3C1OWO2 | 11 | K₁₁ | 14.8 |
| III | 3PP1 | 13 | K₂₂ | 7.4 |
| III | 3CPO1 | 4 | K₃₃ | 15.6 |
| III | 5CC3 | 15 | | |
| III | 4CC3 | 8 | | |
| III | 3CC2 | 4 | | |

### Nematic Phase Liquid Crystal Composition LC6

TABLE 7

Percentages by weight of each component and performance parameters of the liquid crystal composition

| Category | Compound code | Percentage by weight (%) | Performance parameter | Parameter value |
|---|---|---|---|---|
| II | 2CPWO2 | 4 | Δn | 0.1088 |
| II | 3CPWO2 | 9 | ε_{//} | 3.5 |
| II | 2CC1OWO2 | 8 | ε_{⊥} | 3.9 |
| II | 3CC1OWO2 | 15 | Δε | -3.4 |
| II | 3C1OWO2 | 11 | Cp | 74 |
| III | 3PP1 | 15 | γ1 | 98 |
| III | 3CPO2 | 4 | K₁₁ | 14.8 |
| III | 5CC3 | 18.5 | K₂₂ | 7.4 |
| III | 4CC3 | 6 | K₃₃ | 15.4 |
| V | 3CPP1 | 8.5 | | |
| V | 3CPP2 | 1 | | |

### Nematic Phase Liquid Crystal Composition LC7

TABLE 8

Percentages by weight of each component and performance parameters of the liquid crystal composition

| Category | Compound code | Percentage by weight (%) | Performance parameter | Parameter value |
|---|---|---|---|---|
| II | 2CPWO2 | 2 | Δn | 0.1040 |
| II | 3CPWO2 | 11.5 | ε_{//} | 3.4 |
| II | 3CC1OWO2 | 14 | ε_{⊥} | 5.8 |
| II | 3C1OWO2 | 11.5 | Δε | -2.4 |
| III | 5PP1 | 13 | Cp | 76.5 |
| III | 3CPO1 | 5.5 | γ1 | 89.3 |
| III | 5CC3 | 15 | K₁₁ | 15.1 |
| III | 4CC3 | 10 | K₂₂ | 7.6 |
| III | 3CC2 | 5 | K₃₃ | 15.2 |
| V | 3CPP1 | 8.5 | | |
| V | 3CPP2 | 4 | | |

### Nematic Phase Liquid Crystal Composition LC8

TABLE 9

Percentages by weight of each component and performance parameters of the liquid crystal composition

| Category | Compound code | Percentage by weight (%) | Performance parameter | Parameter value |
|---|---|---|---|---|
| II | 2CPWO2 | 3 | Δn | 0.1020 |
| II | 3CPWO2 | 10 | ε_{//} | 3.5 |
| II | 2CC1OWO2 | 8 | ε_{⊥} | 5.8 |
| II | 3CC1OWO2 | 15 | Δε | -2.3 |
| II | 3C1OWO2 | 11 | Cp | 75.5 |
| III | 3PP1 | 12 | γ1 | 81.2 |
| III | 3CPO1 | 4 | K₁₁ | 14.6 |
| III | 5CC3 | 18.5 | K₂₂ | 7.3 |
| III | 4CC3 | 7 | K₃₃ | 15.2 |
| III | 3CC2 | 7 | | |
| V | 3CPP1 | 4.5 | | |

### Nematic Phase Liquid Crystal Composition LC10

TABLE 10

Percentages by weight of each component and performance parameters of the liquid crystal composition

| Category | Compound code | Percentage by weight (%) | Performance parameter | Parameter value |
|---|---|---|---|---|
| II | 2CPWO2 | 5 | Δn | 0.1060 |
| II | 3CPWO2 | 10 | ε_{//} | 3.5 |
| II | 2CC1OWO2 | 5 | ε_{⊥} | 6.9 |
| II | 3CC1OWO2 | 15 | Δε | -3.4 |
| II | 3C1OWO2 | 12 | Cp | 77 |
| III | 5PP1 | 14 | γ1 | 102 |
| III | 3CPO2 | 3 | K₁₁ | 15.2 |
| III | 5CC3 | 18 | K₂₂ | 7.6 |
| III | 4CC3 | 6 | K₃₃ | 15.4 |
| III | 3CC2 | 4 | | |
| V | 3CPP2 | 8 | | |

### Nematic Phase Liquid Crystal Composition LC11

TABLE 11

Percentages by weight of each component and performance parameters of the liquid crystal composition

| Category | Compound code | Percentage by weight (%) | Performance parameter | Parameter value |
|---|---|---|---|---|
| II | 2CPWO2 | 8 | Δn | 0.1080 |
| II | 3CPWO2 | 10 | ε_{//} | 3.3 |
| II | 3CCWO2 | 5 | ε_{⊥} | 6.9 |
| II | 2CC1OWO2 | 6 | Δε | -3.6 |
| II | 3CC1OWO2 | 13 | Cp | 75 |
| II | 3C1OWO1 | 4 | γ1 | 96.0 |
| II | 3C1OWO2 | 12 | K₁₁ | 14.8 |
| III | 5PP1 | 13 | K₂₂ | 7.4 |
| III | 3CPO2 | 6 | K₃₃ | 14.9 |
| III | 5CC3 | 15 | | |
| III | 4CC3 | 2 | | |
| V | 3CPP2 | 6 | | |

### Nematic Phase Liquid Crystal Composition LC12

TABLE 12

Percentages by weight of each component and performance parameters of the liquid crystal composition

| Category | Compound code | Percentage by weight (%) | Performance parameter | Parameter value |
|---|---|---|---|---|
| II | 2CPWO2 | 3 | Δn | 0.1040 |
| II | 3CPWO2 | 10 | ε_{//} | 3.6 |
| II | 2CC1OWO2 | 7 | ε_{⊥} | 6.9 |
| II | 3CC1OWO2 | 15 | Δε | -3.3 |
| II | 3C1OWO2 | 12 | Cp | 73 |
| III | 5PP1 | 7 | γ1 | 88.0 |
| III | 3CPO2 | 6 | K₁₁ | 14.6 |
| III | 5CC3 | 18 | K₂₂ | 7.3 |
| III | 4CC3 | 6 | K₃₃ | 14.8 |
| III | 3CC2 | 7 | | |
| IV | 3PGKF | 5 | | |
| V | 3CPP2 | 4 | | |

### Nematic Phase Liquid Crystal Composition LC13

TABLE 13

Percentages by weight of each component and performance parameters of the liquid crystal composition

| Category | Compound code | Percentage by weight (%) | Performance parameter | Parameter value |
|---|---|---|---|---|
| II | 3CPWO2 | 11 | Δn | 0.1060 |
| II | 3CC1OWO2 | 14 | ε_{//} | 3.4 |
| II | 3C1OWO2 | 12 | ε_{⊥} | 6.9 |
| III | 5PPO1 | 6 | Δε | -3.5 |
| III | 3CPO2 | 10 | Cp | 74.5 |
| III | 5CC3 | 15 | γ1 | 102.1 |
| III | 4CC3 | 9 | K₁₁ | 15.2 |
| III | 3CC2 | 5 | K₂₂ | 7.6 |
| III | 3PPO1 | 6 | K₃₃ | 15.4 |
| V | 3CPP1 | 6 | | |
| V | 3CPP2 | 6 | | |

### Nematic Phase Liquid Crystal Composition LC14

TABLE 14

Percentages by weight of each component and performance parameters of the liquid crystal composition

| Category | Compound code | Percentage by weight (%) | Performance parameter | Parameter value |
|---|---|---|---|---|
| II | 3CPWO2 | 11 | Δn | 0.1080 |
| II | 3CC1OWO2 | 14 | ε_{//} | 3.6 |
| II | 3C1OWO2 | 12 | ε_{⊥} | 6.9 |
| III | 5PP1 | 7 | Aε | -3.3 |
| III | 3CPO2 | 10 | Cp | 77.5 |
| III | 5CC3 | 15 | γ1 | 99.1 |
| III | 4CC3 | 9 | K₁₁ | 14.8 |
| III | 3CC2 | 5 | K₂₂ | 7.4 |
| IV | 3PGKF | 5 | K₃₃ | 15.4 |
| V | 3CPP1 | 6 | | |
| V | 3CPP2 | 6 | | |

### Nematic Phase Liquid Crystal Composition LC15

TABLE 15

Percentages by weight of each component and performance parameters of the liquid crystal composition

| Category | Compound code | Percentage by weight (%) | Performance parameter | Parameter value |
|---|---|---|---|---|
| II | 2CPWO2 | 3 | Δn | 0.1065 |
| II | 3CPWO2 | 10.5 | ε_{//} | 3.4 |
| II | 2CC1OWO2 | 7 | ε_{⊥} Sj. | 6.8 |
| II | 3CC1OWO2 | 15 | Δε | -3.4 |
| II | 3C1OWO2 | 12 | Cp | 75.5 |
| III | 5PP1 | 7 | γ1 | 96.1 |
| III | 3CPO2 | 6 | K₁₁ | 14.5 |
| III | 5CC3 | 18 | K₂₂ | 7.3 |
| III | 4CC3 | 6 | K₃₃ | 15.1 |
| III | 3CC2 | 7 | | |
| IV | 3PGKF | 5 | | |
| V | 3CPP2 | 3.5 | | |

### Nematic Phase Liquid Crystal Composition LC16

TABLE 16

Percentages by weight of each component and performance parameters of the liquid crystal composition

| Category | Compound code | Percentage by weight (%) | Performance parameter | Parameter value |
|---|---|---|---|---|
| II | 2CPWO2 | 3 | Δn | 0.1075 |
| II | 3CPWO2 | 10 | ε_{//} | 3.5 |
| II | 2CC1OWO2 | 7 | ε_{⊥} | 6.8 |
| II | 3CC1OWO2 | 15 | Δε | -3.3 |
| II | 3C1OWO2 | 12 | Cp | 74.5 |
| III | 5PPO1 | 6 | γ1 | 94.1 |
| III | 3CPO2 | 7 | K₁₁ | 14.5 |
| III | 5CC3 | 18 | K₂₂ | 7.3 |
| III | 4CC3 | 6 | K₃₃ | 15.1 |
| III | 3CC2 | 7 | | |
| III | 3PPO1 | 6 | | |
| V | 3CPP2 | 3 | | |

### Nematic Phase Liquid Crystal Composition LC17

TABLE 17

Percentages by weight of each component and performance parameters of the liquid crystal composition

| Category | Compound code | Percentage by weight (%) | Performance parameter | Parameter value |
|---|---|---|---|---|
| II | 2CPWO2 | 8 | Δn | 0.1015 |
| II | 3CPWO2 | 8.5 | ε_{//} | 3.2 |
| II | 3CWO2 | 16 | ε_{⊥} | 6.6 |
| II | 5CWO2 | 8 | Δε | -3.4 |
| II | 3CCWO2 | 11 | Cp | 78.5 |
| III | 3CC2 | 6 | γ1 | 92.1 |
| III | 3CPO1 | 5 | K₁₁ | 14.3 |
| III | 5CC3 | 18 | K₂₂ | 7.7 |
| III | 4CC3 | 9 | K₃₃ | 15.2 |
| V | 3CPP1 | 2.5 | | |
| V | 3CPP2 | 8 | | |

### Nematic Phase Liquid Crystal Composition LC18

TABLE 18

Percentages by weight of each component and performance parameters of the liquid crystal composition

| Category | Compound code | Percentage by weight (%) | Performance parameter | Parameter value |
|---|---|---|---|---|
| II | 2CPWO2 | 10 | Δn | 0.1115 |
| II | 3CWO2 | 15 | ε_{//} | 3.4 |
| II | 5CWO2 | 5 | ε_{⊥} | 6.8 |
| II | 2CCWO2 | 10 | Δε | -3.4 |
| II | 3CCWO2 | 11 | Cp | 78.5 |
| III | 5CC3 | 18 | γ1 | 92.1 |
| III | 4CC3 | 8 | K₁₁ | 13.8 |
| III | 3CC2 | 4 | K₂₂ | 6.9 |
| III | 5PP1 | 3.5 | K₃₃ | 14.8 |
| III | 3CPO1 | 4.5 | | |
| V | 3CPP1 | 3 | | |
| V | 3CPP2 | 8 | | |

### Nematic Phase Liquid Crystal Composition LC19

TABLE 19

Percentages by weight of each component and performance parameters of the liquid crystal composition

| Category | Compound code | Percentage by weight (%) | Performance parameter | Parameter value |
|---|---|---|---|---|
| II | 3CCWO3 | 7 | Δn | 0.1065 |
| II | 3CWO2 | 14 | ε_{//} | 3.2 |
| II | 3CCWO2 | 10 | ε_{⊥} | 6.6 |
| II | 1PWO2 | 5 | Δε | -3.4 |
| II | 3CCWO1 | 8 | Cp | 72.5 |
| II | 4PWO2 | 6.5 | γ1 | 91.1 |
| II | 1PWO4 | 5 | K₁₁ | 14.8 |
| III | 3CC1V1 | 8 | K₂₂ | 7.4 |
| III | 5CC3 | 10.5 | K₃₃ | 15.3 |
| III | 4CC3 | 6 | | |
| III | 3CC2 | 6 | | |
| IV | 2PWP1 | 5 | | |
| V | 3CCP1 | 9 | | |

### Nematic Phase Liquid Crystal Composition LC20

TABLE 20

Percentages by weight of each component and performance parameters of the liquid crystal composition

| Category | Compound code | Percentage by weight (%) | Performance parameter | Parameter value |
|---|---|---|---|---|
| II | 3CCWO3 | 7 | Δn | 0.1045 |
| II | 3CWO2 | 14 | ε_{//} | 3.2 |
| II | 3CCWO2 | 10 | ε_{⊥} | 6.5 |
| II | 1PWO2 | 8.5 | Δε | -3.3 |
| II | 3CCWO1 | 8 | Cp | 76.5 |
| II | 1PWO4 | 8 | γ1 | 91.1 |
| III | 3CC1V1 | 8 | K₁₁ | 14.6 |
| III | 5CC3 | 10.5 | K₂₂ | 7.3 |
| III | 4CC3 | 6 | K₃₃ | 15.6 |
| III | 3CC2 | 6 | | |
| IV | 2PWP1 | 5 | | |
| V | 3CCP1 | 9 | | |

### Nematic Phase Liquid Crystal Composition LC21

TABLE 21

Percentages by weight of each component and performance parameters of the liquid crystal composition

| Category | Compound code | Percentage by weight (%) | Performance parameter | Parameter value |
|---|---|---|---|---|
| II | 2CPWO2 | 4 | Δn | 0.1005 |
| II | 3CPWO2 | 10.5 | ε_{//} | 3.2 |
| II | 2CC1OWO2 | 7 | ε_{⊥} | 6.6 |
| II | 1PWO4 | 7 | Δε | -3.4 |
| II | 3C1OWO2 | 12 | Cp | 69.5 |
| II | 1PWO2 | 8 | γ1 | 94.1 |
| III | 5PP1 | 15 | K₁₁ | 13.8 |
| III | 3CPO2 | 4 | K₂₂ | 6.9 |
| III | 5CC3 | 18.5 | K₃₃ | 14.5 |
| III | 4CC3 | 6 | | |
| V | 3CCP1 | 8 | | |

### Nematic Phase Liquid Crystal Composition LC22

TABLE 22

Percentages by weight of each component and performance parameters of the liquid crystal composition

| Category | Compound code | Percentage by weight (%) | Performance parameter | Parameter value |
|---|---|---|---|---|
| II | 2CPWO2 | 4 | Δn | 0.1001 |
| II | 3CPWO2 | 10.5 | ε_{//} | 3.0 |
| II | 2CC1OWO2 | 7 | ε_{⊥} | 6.3 |
| II | 1PWO4 | 5 | Δε | -3.3 |
| II | 3C1OWO2 | 12 | Cp | 68.5 |
| II | 1PWO2 | 5 | γ1 | 89.1 |
| III | 5PP1 | 15 | K₁₁ | 13.6 |
| III | 3CPO2 | 4 | K₂₂ | 6.8 |
| III | 5CC3 | 18.5 | K₃₃ | 14.2 |
| III | 4CC3 | 11 | | |
| V | 3CCP1 | 8 | | |

### Nematic Phase Liquid Crystal Composition LC24

TABLE 23

Percentages by weight of each component and performance parameters of the liquid crystal composition

| Category | Compound code | Percentage by weight (%) | Performance parameter | Parameter value |
|---|---|---|---|---|
| II | 3CCWO3 | 7 | Δn | 0.1041 |
| II | 3CWO2 | 14 | ε_{//} | 3.3 |
| II | 3CCWO2 | 10 | ε_{⊥} | 6.5 |
| II | 3PWO2 | 10 | Δε | -3.2 |
| II | 3CCWO1 | 8 | Cp | 69.5 |
| II | 4PWO2 | 6.5 | γ1 | 95.1 |
| III | 3CC1V1 | 8 | K₁₁ | 14.6 |
| III | 5CC3 | 10.5 | K₂₂ | 7.3 |
| III | 4CC3 | 6 | K₃₃ | 15.2 |
| III | 3CC2 | 6 | | |
| IV | 3PDDF | 5 | | |
| V | 3CCP1 | 9 | | |

### Nematic Phase Liquid Crystal Composition LC25

TABLE 24

Percentages by weight of each component and performance parameters of the liquid crystal composition

| Category | Compound code | Percentage by weight (%) | Performance parameter | Parameter value |
|---|---|---|---|---|
| II | 3CCWO3 | 7 | Δn | 0.1038 |
| II | 3CWO2 | 14 | ε_{//} | 3.2 |
| II | 3CCWO2 | 10 | ε_{⊥} | 6.3 |
| II | 3PWO2 | 10 | Δε | -3.1 |
| II | 3CCWO1 | 8 | Cp | 71.5 |
| II | 4PWO2 | 6.5 | γ1 | 91.1 |
| III | 3CC1V1 | 8 | K₁₁ | 14.2 |
| III | 5CC3 | 10.5 | K₂₂ | 7.1 |
| III | 4CC3 | 6 | K₃₃ | 14.6 |
| III | 3CC2 | 6 | | |
| IV | 5PDP2 | 5 | | |
| V | 3CCP1 | 9 | | |

0.265 parts by mass of a compound represented by formula I-3 is added to 100 parts by mass of the liquid crystal composition LC1, and a liquid crystal composition containing a polymerizable compound is obtained as Example 1.

0.265 parts by mass of a compound represented by formula I-3 and 0.017 parts by mass of a compound represented by formula VI-2 are added to 100 parts by mass of the liquid crystal composition LC1, and a liquid crystal composition containing a polymerizable compound is obtained as Example 2.

0.265 parts by mass of a compound represented by formula I-3 and 0.032 parts by mass of a compound represented by formula VI-2 are added to 100 parts by mass of the liquid crystal composition LC1, and a liquid crystal composition containing a polymerizable compound is obtained as Example 3.

0.265 parts by mass of a compound represented by formula I-3 and 0.05 parts by mass of a compound represented by formula VI-2 are added to 100 parts by mass of the liquid crystal composition LC1, and a liquid crystal composition containing a polymerizable compound is obtained as Example 4.

0.250 parts by mass of a compound represented by formula I-3 and 0.05 parts by mass of a compound represented by formula VI-2 are added to 100 parts by mass of the liquid crystal composition LC1, and a liquid crystal composition containing a polymerizable compound is obtained as Example 5.

0.280 parts by mass of a compound represented by formula I-3 and 0.05 parts by mass of a compound represented by formula VI-2 are added to 100 parts by mass of the liquid crystal composition LC1, and a liquid crystal composition containing a polymerizable compound is obtained as Example 6.

0.320 parts by mass of a compound represented by formula I-3 and 0.05 parts by mass of a compound represented by formula VI-2 are added to 100 parts by mass of the liquid crystal composition LC1, and a liquid crystal composition containing a polymerizable compound is obtained as Example 7.

0.265 parts by mass of a compound represented by formula I-3 and 0.05 parts by mass of a compound represented by formula VI-2 are added to 100 parts by mass of the liquid crystal composition LC2, and a liquid crystal composition containing a polymerizable compound is obtained as Example 8.

0.265 parts by mass of a compound represented by formula I-3 and 0.05 parts by mass of a compound represented by formula VI-2 are added to 100 parts by mass of the liquid crystal composition LC3, and a liquid crystal composition containing a polymerizable compound is obtained as Example 9.

0.265 parts by mass of a compound represented by formula I-3 and 0.05 parts by mass of a compound represented by formula VI-2 are added to 100 parts by mass of the liquid crystal composition LC4, and a liquid crystal composition containing a polymerizable compound is obtained as Example 10.

0.265 parts by mass of a compound represented by formula I-3 and 0.05 parts by mass of a compound represented by formula VI-2 are added to 100 parts by mass of the liquid crystal composition LC5, and a liquid crystal composition containing a polymerizable compound is obtained as Example 11.

0.25 parts by mass of a compound represented by formula I-3 and 0.017 parts by mass of a compound represented by formula VI-2 are added to 100 parts by mass of the liquid crystal composition LC6, and a liquid crystal composition containing a polymerizable compound is obtained as Example 12.

0.25 parts by mass of a compound represented by formula I-3 and 0.024 parts by mass of a compound represented by formula VI-2 are added to 100 parts by mass of the liquid crystal composition LC7, and a liquid crystal composition containing a polymerizable compound is obtained as Example 13.

0.25 parts by mass of a compound represented by formula I-3 and 0.026 parts by mass of a compound represented by formula VI-2 are added to 100 parts by mass of the liquid crystal composition LC8, and a liquid crystal composition containing a polymerizable compound is obtained as Example 14.

0.25 parts by mass of a compound represented by formula I-3 and 0.028 parts by mass of a compound represented by formula VI-2 are added to 100 parts by mass of the liquid crystal composition LC9, and a liquid crystal composition containing a polymerizable compound is obtained as Example 15.

0.25 parts by mass of a compound represented by formula I-3 and 0.032 parts by mass of a compound represented by formula VI-2 are added to 100 parts by mass of the liquid crystal composition LC10, and a liquid crystal composition containing a polymerizable compound is obtained as Example 16.

0.28 parts by mass of a compound represented by formula I-1 and 0.017 parts by mass of a compound represented by formula VI-2 are added to 100 parts by mass of the liquid crystal composition LC11, and a liquid crystal composition containing a polymerizable compound is obtained as Example 17.

0.28 parts by mass of a compound represented by formula I-1 and 0.024 parts by mass of a compound represented by formula VI-2 are added to 100 parts by mass of the liquid crystal composition LC12, and a liquid crystal composition containing a polymerizable compound is obtained as Example 18.

0.28 parts by mass of a compound represented by formula I-1 and 0.026 parts by mass of a compound represented by formula VI-2 are added to 100 parts by mass of the liquid crystal composition LC13, and a liquid crystal composition containing a polymerizable compound is obtained as Example 19.

0.28 parts by mass of a compound represented by formula I-1 and 0.028 parts by mass of a compound represented by formula VI-2 are added to 100 parts by mass of the liquid crystal composition LC14, and a liquid crystal composition containing a polymerizable compound is obtained as Example 20.

0.28 parts by mass of a compound represented by formula I-1 and 0.032 parts by mass of a compound represented by formula VI-2 are added to 100 parts by mass of the liquid crystal composition LC15, and a liquid crystal composition containing a polymerizable compound is obtained as Example 21.

0.32 parts by mass of a compound represented by formula I-2 and 0.017 parts by mass of a compound represented by formula VI-2 are added to 100 parts by mass of the liquid crystal composition LC16, and a liquid crystal composition containing a polymerizable compound is obtained as Example 22.

0.32 parts by mass of a compound represented by formula I-2 and 0.024 parts by mass of a compound represented by formula VI-2 are added to 100 parts by mass of the liquid crystal composition LC17, and a liquid crystal composition containing a polymerizable compound is obtained as Example 23.

0.32 parts by mass of a compound represented by formula I-2 and 0.026 parts by mass of a compound represented by formula VI-2 are added to 100 parts by mass of the liquid crystal composition LC18, and a liquid crystal composition containing a polymerizable compound is obtained as Example 24.

0.32 parts by mass of a compound represented by formula I-2 and 0.028 parts by mass of a compound represented by formula VI-2 are added to 100 parts by mass of the liquid crystal composition LC19, and a liquid crystal composition containing a polymerizable compound is obtained as Example 25.

0.32 parts by mass of a compound represented by formula I-2 and 0.032 parts by mass of a compound represented by formula VI-2 are added to 100 parts by mass of the liquid crystal composition LC20, and a liquid crystal composition containing a polymerizable compound is obtained as Example 26.

0.265 parts by mass of a compound represented by formula I-3 and 0.05 parts by mass of a compound represented by formula VI-2 are added to 100 parts by mass of the liquid crystal composition LC21, and a liquid crystal composition containing a polymerizable compound is obtained as Example 27.

0.265 parts by mass of a compound represented by formula I-3 and 0.05 parts by mass of a compound represented by formula VI-2 are added to 100 parts by mass of the liquid crystal composition LC22, and a liquid crystal composition containing a polymerizable compound is obtained as Example 28.

0.265 parts by mass of a compound represented by formula I-3 and 0.05 parts by mass of a compound represented by formula VI-2 are added to 100 parts by mass of the liquid crystal composition LC23, and a liquid crystal composition containing a polymerizable compound is obtained as Example 29.

0.265 parts by mass of a compound represented by formula I-3 and 0.05 parts by mass of a compound represented by formula VI-2 are added to 100 parts by mass of the liquid crystal composition LC24, and a liquid crystal composition containing a polymerizable compound is obtained as Example 30.

0.265 parts by mass of a compound represented by formula I-3 and 0.05 parts by mass of a compound represented by formula VI-2 are added to 100 parts by mass of the liquid crystal composition LC25, and a liquid crystal composition containing a polymerizable compound is obtained as Example 31.

### Comparative Example 1

0.265 parts by mass of a compound represented by formula RM-1 and 0.05 parts by mass of a compound represented by formula VI-2 are added to 100 parts by mass of the liquid crystal composition LC1, and a liquid crystal composition containing a polymerizable compound is obtained as Comparative example 1.

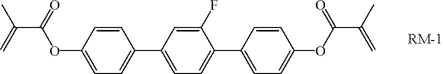 [SMILES: C=C(C)C(=O)Oc1ccc(-c2ccc(-c3ccc(OC(=O)C(=C)C)cc3)c(F)c2)cc1]

The liquid crystal composition containing a polymerizable compound is injected into a PSVA testing cassete with a cell gap of 3.2 µm by a vacuum infusion process. Then, a fluorescent lamp is used to irradiate the liquid crystal cell with ultraviolet rays through a color filter for filtering out ultraviolet rays of 310 nm or less. At the moment, the ultraviolet ray is adjusted to have an illuminance of 100 mW/cm2 and a cumulative irradiation light amount of 30 J/cm2, which are measured under a condition of a center wavelength of 365 nm (irradiation condition 1). Then, a fluorescent UV lamp is used and the ultraviolet ray is adjusted to have an illuminance of 3 mW/cm2 and a cumulative irradiation light amount of 10 J/cm2, which are measured at a condition of a center wavelength of 313 nm (irradiation condition 2). UV1 represents the ultraviolet irradiation process under the irradiation condition 1, and UV2 represents the ultraviolet irradiation processes under the irradiation condition 1 and irradiation condition 2.

### Effect Test

### 1. Pretilt Angle Change

Mixtures prepared by various polymerizable compounds and liquid crystal compounds are injected into testing cassetes. The polymerizable compounds are polymerized by ultraviolet irradiation, and then the pretilt angles of the testing cassetes after the UV1 and UV2 irradiation process are respectively determined. It is preferable that the pretilt angle change is small after the UV1 and UV2 processes.

In different temperature ranges, there is no significant difference in pretilt angles in different areas after the UV2 process, which can effectively improve the area mura problem.

### 2. Conversion Rate of the Polymerizable Compound

A polymerizable compound is added into a composition, and the polymerizable compound is consumed by polymerization to form a polymer. The conversion rate of this reaction is preferably a large conversion rate.

This is because the residual amount of polymer compound (the amount of the unreacted polymerizable compound) is preferably small from the viewpoint of image afterimage.

TABLE 25

| | Comparative example 1 | Example 1 | Example 2 | Example 3 |
|---|---|---|---|---|
| Liquid crystal composition (parts by mass) | 100 | 100 | 100 | 100 |
| RM (parts by mass) | 0.265 | 0.265 | 0.265 | 0.265 |
| RM category | RM-1 | I-3 | I-3 | I-3 |
| Residual amount of polymerizable compound [ppm] (irradiation condition 1) | 0.22 | 0.158 | 0.165 | 0.178 |
| Conversion rate (irradiation condition 1) | 16.90% | 40.38% | 37.74% | 32.83% |
| Pretilt angle (irradiation condition 1) | 2.5 | 2.5 | 2.4 | 2.3 |
| Residual amount of polymerizable compound [ppm] (irradiation condition 1 and irradiation condition 2) | Below lower limit of detection | Below lower limit of detection | Below lower limit of detection | Below lower limit of detection |
| Pretilt angle (irradiation condition 1 and irradiation condition 2) | 2.1 | 2.4 | 2.3 | 2.2 |
| Pretilt angle change | 0.4 | 0.1 | 0.1 | 0.1 |

TABLE 26

| | Example 4 | Example 5 | Example 6 | Example 7 |
|---|---|---|---|---|
| Liquid crystal composition (parts by mass) | 100 | 100 | 100 | 100 |
| RM (parts by mass) | 0.265 | 0.25 | 0.28 | 0.32 |
| RM category | I-3 | I-3 | I-3 | I-3 |
| Residual amount of polymerizable compound [ppm] (irradiation condition 1) | 0.183 | 0.164 | 0.18 | 0.22 |
| Conversion rate (irradiation condition 1) | 30.94% | 34.40% | 35.71% | 31.25% |
| Pretilt angle (irradiation condition 1) | 2.2 | 2.0 | 2.8 | 3.2 |
| Residual amount of polymerizable compound [ppm] (irradiation condition 1 and irradiation condition 2) | Below lower limit of detection | Below lower limit of detection | Below lower limit of detection | Below lower limit of detection |
| Pretilt angle (irradiation condition 1 and irradiation condition 2) | 2.0 | 1.9 | 2.6 | 3.1 |
| Pretilt angle change | 0.2 | 0.1 | 0.2 | 0.1 |

TABLE 27

| | Example 8 | Example 9 | Example 10 | Example 11 |
|---|---|---|---|---|
| Liquid crystal composition (parts by mass) | 100 | 100 | 100 | 100 |
| RM (parts by mass) | 0.265 | 0.265 | 0.265 | 0.265 |
| RM category | I-3 | I-3 | I-3 | I-3 |
| Residual amount of polymerizable compound [ppm] (irradiation condition 1) | 0.178 | 0.185 | 0.182 | 0.183 |
| Conversion rate (irradiation condition 1) | 32.83% | 30.19% | 31.32% | 30.94% |
| Pretilt angle (irradiation condition 1) | 2.2 | 2.1 | 2.3 | 2.2 |
| Residual amount of polymerizable compound [ppm] (irradiation condition 1 and irradiation condition 2) | Below lower limit of detection | Below lower limit of detection | Below lower limit of detection | Below lower limit of detection |
| Pretilt angle (irradiation condition 1 and irradiation condition 2) | 2.1 | 2.0 | 2.1 | 2.1 |
| Pretilt angle change | 0.1 | 0.1 | 0.2 | 0.1 |

TABLE 28

| | Example 12 | Example 13 | Example 14 | Example 15 |
|---|---|---|---|---|
| Liquid crystal composition (parts by mass) | 100 | 100 | 100 | 100 |
| RM (parts by mass) | 0.25 | 0.25 | 0.25 | 0.25 |
| RM category | I-3 | I-3 | I-3 | I-3 |
| Residual amount of polymerizable compound [ppm] (irradiation condition 1) | 0.178 | 0.174 | 0.172 | 0.17 |
| Conversion rate (irradiation condition 1) | 28.80% | 30.40% | 31.20% | 32.00% |
| Pretilt angle (irradiation condition 1) | 2.0 | 2.0 | 2.0 | 1.9 |
| Residual amount of polymerizable compound [ppm] (irradiation condition 1 and irradiation condition 2) | Below lower limit of detection | Below lower limit of detection | Below lower limit of detection | Below lower limit of detection |
| Pretilt angle (irradiation condition 1 and irradiation condition 2) | 1.9 | 1.9 | 1.9 | 1.8 |
| Pretilt angle change | 0.1 | 0.1 | 0.1 | 0.1 |

TABLE 29

| | Example 16 | Example 17 | Example 18 | Example 19 |
|---|---|---|---|---|
| Liquid crystal composition (parts by mass) | 100 | 100 | 100 | 100 |
| RM (parts by mass) | 0.25 | 0.28 | 0.28 | 0.28 |
| RM category | I-3 | I-1 | I-1 | I-1 |
| Residual amount of polymerizable compound [ppm] (irradiation condition 1) | 0.171 | 0.182 | 0.183 | 0.183 |
| Conversion rate (irradiation condition 1) | 31.60% | 35.00% | 34.64% | 34.64% |
| Pretilt angle (irradiation condition 1) | 1.9 | 2.9 | 2.8 | 2.8 |
| Residual amount of polymerizable compound [ppm] (irradiation condition 1 and irradiation condition 2) | Below lower limit of detection | Below lower limit of detection | Below lower limit of detection | Below lower limit of detection |
| Pretilt angle (irradiation condition 1 and irradiation condition 2) | 1.8 | 2.8 | 2.7 | 2.7 |
| Pretilt angle change | 0.1 | 0.1 | 0.1 | 0.1 |

TABLE 30

| | Example 20 | Example 21 | Example 22 | Example 23 |
|---|---|---|---|---|
| Liquid crystal composition (parts by mass) | 100 | 100 | 100 | 100 |
| RM (parts by mass) | 0.28 | 0.28 | 0.32 | 0.32 |
| RM category | I-1 | I-1 | I-2 | I-2 |
| Residual amount of polymerizable compound [ppm] (irradiation condition 1) | 0.184 | 0.186 | 0.21 | 0.2 |
| Conversion rate (irradiation condition 1) | 34.29% | 33.57% | 34.38% | 37.50% |
| Pretilt angle (irradiation | 2.7 | 2.6 | 3.3 | 3.2 |
| condition 1) | | | | |
| Residual amount of polymerizable compound [ppm] (irradiation condition 1 and irradiation condition 2) | Below lower limit of detection | Below lower limit of detection | Below lower limit of detection | Below lower limit of detection |
| Pretilt angle (irradiation condition 1 and irradiation condition 2) | 2.5 | 2.5 | 3.2 | 3.1 |
| Pretilt angle change | 0.2 | 0.1 | 0.1 | 0.1 |

TABLE 31

| | Example 24 | Example 25 | Example 26 | Example 27 |
|---|---|---|---|---|
| Liquid crystal composition (parts by mass) | 100 | 100 | 100 | 100 |
| RM (parts by mass) | 0.32 | 0.32 | 0.32 | 0.265 |
| RM category | I-2 | I-2 | I-2 | I-3 |
| Residual amount of polymerizable compound [ppm] (irradiation condition 1) | 0.19 | 0.19 | 0.19 | 0.18 |
| Conversion rate (irradiation condition 1) | 40.63% | 40.63% | 40.63% | 32.08% |
| Pretilt angle (irradiation condition 1) | 3.2 | 3.2 | 3.1 | 2.2 |
| Residual amount of polymerizable compound [ppm] (irradiation condition 1 and irradiation condition 2) | Below lower limit of detection | Below lower limit of detection | Below lower limit of detection | Below lower limit of detection |
| Pretilt angle (irradiation condition 1 and irradiation condition 2) | 3.0 | 3.1 | 3.0 | 2.1 |
| Pretilt angle change | 0.2 | 0.1 | 0.1 | 0.1 |

TABLE 32

| | Example 28 | Example 29 | Example 30 | Example 31 |
|---|---|---|---|---|
| Liquid crystal composition (parts by mass) | 100 | 100 | 100 | 100 |
| RM (parts by mass) | 0.265 | 0.265 | 0.265 | 0.265 |
| RM category | I-3 | I-3 | I-3 | I-3 |
| Residual amount of polymerizable compound [ppm] (irradiation condition 1) | 0.18 | 0.18 | 0.18 | 0.182 |
| Conversion rate (irradiation condition 1) | 32.08% | 32.08% | 32.08% | 31.32% |
| Pretilt angle (irradiation condition 1) | 2.0 | 1.9 | 1.8 | 1.8 |
| Residual amount of polymerizable compound [ppm] (irradiation condition 1 and irradiation condition 2) | Below lower limit of detection | Below lower limit of detection | Below lower limit of detection | Below lower limit of detection |
| Pretilt angle (irradiation condition 1 and irradiation condition 2) | 1.8 | 1.8 | 1.6 | 1.6 |
| Pretilt angle change | 0.2 | 0.1 | 0.2 | 0.2 |

Compared with comparative examples, the liquid crystal composition containing a polymerizable compound involved in the present invention has the advantages of smaller pretilt angle change, less residue and higher conversion rate, reduces the problem of return angle due to the UV2 process and effectively solves the area Mura problem.

### Industrial Applicability

The present invention provides a liquid crystal composition comprising a polymerizable compound, and the use thereof. The liquid crystal composition includes a nematic phase liquid crystal composition and at least comprises one or more polymerizable compounds represented by general formula I. Compared with existing liquid crystal compositions, the polymerizable compound in the liquid crystal composition of the present invention has the advantages of faster polymerization rate, smaller pretilt angle change, higher conversion rate, and less residue, the problem that existing PSVA-type liquid crystal display is bad is mitigated to a large extent, the amount of pretilt angle change is reduced, the area Mura problem is solved, and has good economic value and application prospect.

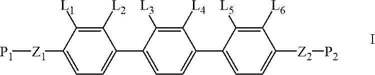

1. A liquid crystal composition, wherein it comprises a nematic phase liquid crystal composition and at least contains one or more polymerizable compounds represented by general formula I: 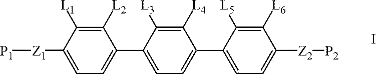
wherein L1, L2, L3, L4, L5, and L6 each independently represent H, —F, —Cl, —CH3, —C2H5, —OCH3, —OC2H5, —CF3 or OCF3, and L3 and L4 are not both H, and at least one of L1, L2, L5, and L6 is —CH3 or —OCH3;
the P1 and P2 each independently represent an acrylate group, a methacrylate group, a fluoroacrylate group, a chloroacrylate group, an ethyleneoxy group, an oxetanyl group, or an epoxy group;
the Z1 and Z2 each independently represent a single bond, —O—, —S—, —CO—, —CO—O—, —O—CO—, —O—CO—O—, —CH═N—, —N═CH—, —N═N—, a C1-C12 alkylene group, or a C2-C12 alkenyl group, wherein one or more hydrogen atoms in the C1-C12 alkylene group or the C2-C12 alkenyl group may each independently be substituted by F, C1 or CN, and one or more non-adjacent —CH2—groups may each independently be replaced by—O—, —S—, —NH—, —CO—, COO—, —OCO—, —OCOO—, —SCO—, —COS— or —C═C— in a way that is not directly connected to each other.

2. The liquid crystal composition according to claim 1, wherein L1, L2, L3, L4, L5, and L6 each independently represent H, —F, —CH3 or —OCH3, and L3 and L4 are not both H.

3. The liquid crystal composition according to claim 2, wherein P1 and P2 each independently represent a methacrylate group, an acrylate group, a fluoroacrylate group or a chloroacrylate group; preferably, P1 and P2 each independently represent a methacrylate group or an acrylate group;
and/or Z1 and Z2 each independently represent a single bond, —O—, —S—, —CO—O—, —O—CO—, a C1-C6 alkylene group or a C2-C6 alkenyl group, wherein one or more hydrogen atoms in the C1-C6 alkylene group or the C2-C6 alkenyl group may each independently be substituted by F, and one or more non-adjacent —CH2— groups may each independently be replaced by—O— in a way that is not directly connected to each other; preferably, Z1 and Z2 each independently represent a single bond, —O—, a C1-C6 alkylene group or an alkoxy group.

4. The liquid crystal composition according to claim 3, wherein the compound represented by general formula I is selected from one or more of I1 - I28: 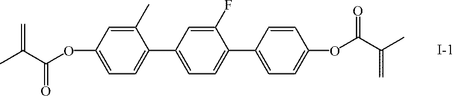 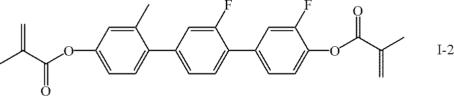 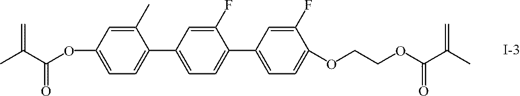 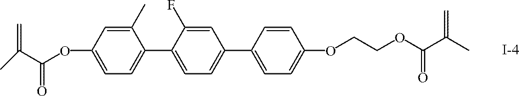 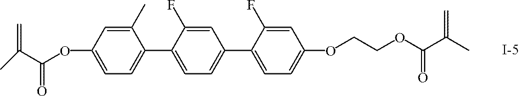 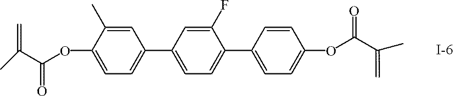 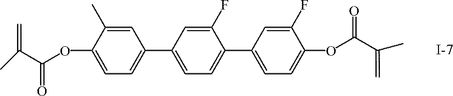 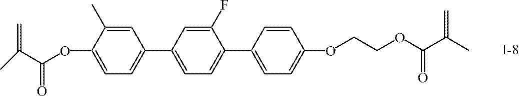 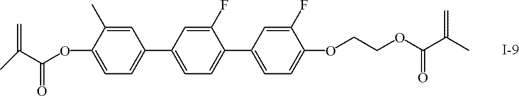 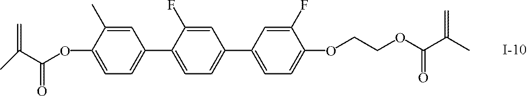 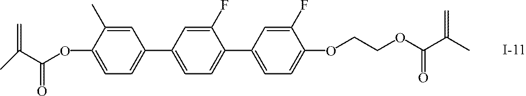 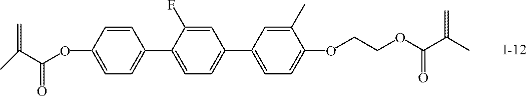 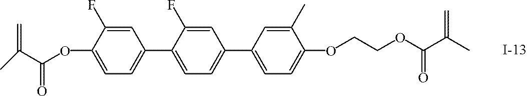 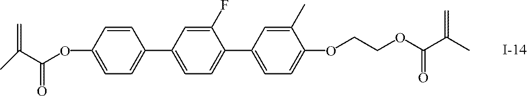 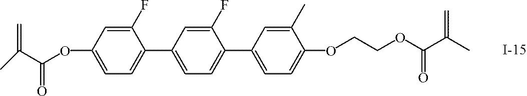 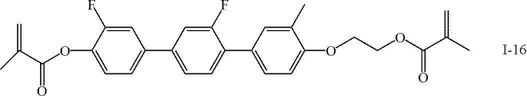 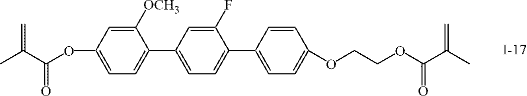 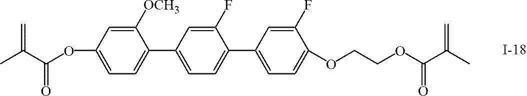 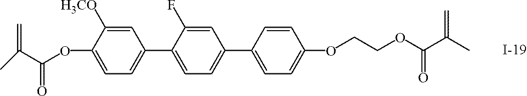 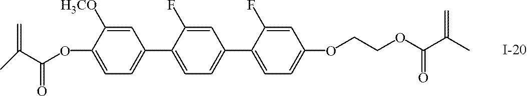 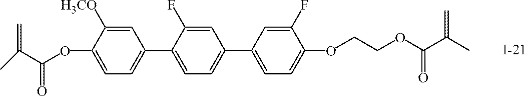 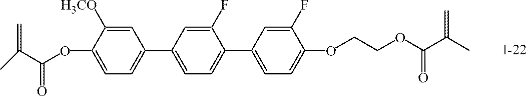 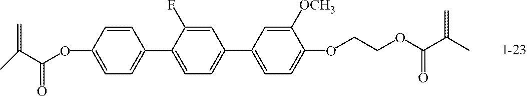 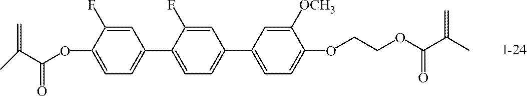 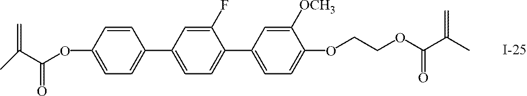 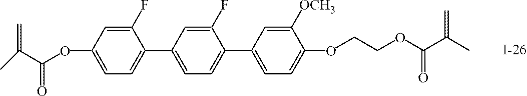 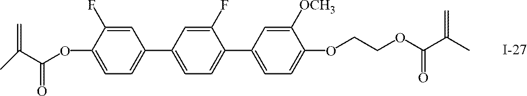 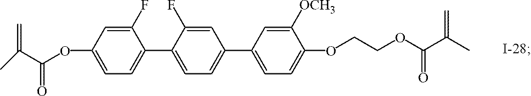
preferably, the compound represented by general formula I is selected from one or more of I1 - I5.

5. The liquid crystal composition according to claim 1, wherein the compound represented by general formula I in the liquid crystal composition has a mass fraction of 0.01-5%, preferably 0.05-1%, further preferably 0.1-0.5%, and more preferably 0.15-0.32%.

6. The liquid crystal composition according to claim 5, wherein the nematic phase liquid crystal composition at least comprises one or more compounds represented by general formula II: 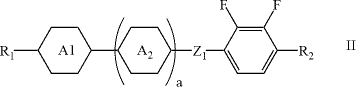
wherein R₁ and R₂ each independently represent a C₁-C₁₂ linear alkyl group, a linear alkoxy group or a C₂-C₁₂ linear alkenyl group;
A₁ and A₂ each independently represent a trans-1,4-cyclohexyl group or a 1,4-phenylene group;
Z1 is a single bond, —CH₂CH₂— or —CH₂O—;
a is 0 or 1;
and the liquid crystal composition at least comprises a compound represented by general formula III: 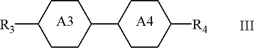
wherein R₃ and R₄ each independently represent a C₁-C₁₂ linear alkyl group, a linear alkoxy group or a C₂-C₁₂ linear alkenyl group;
A₃ and A₄ each independently represent a trans-1,4-cyclohexyl group or a 1,4-phenylene group.

7. The liquid crystal composition according to claim 6, wherein the compound represented by general formula II is selected from one or more of IIA - IIF: 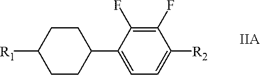 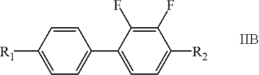 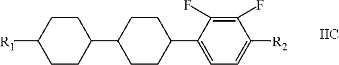 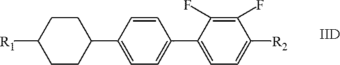 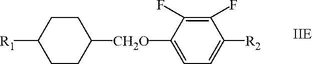 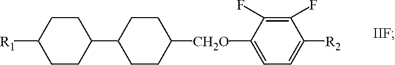
preferably, the compound represented by general formula II is selected from one or more of formulas IIA-1 - IIF-16: 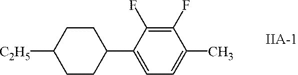 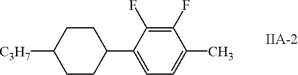 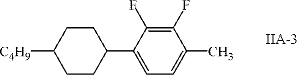 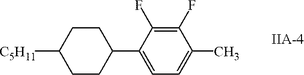 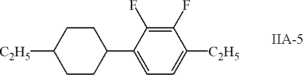 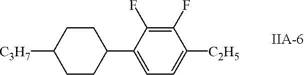 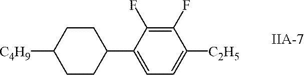 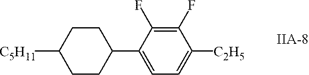 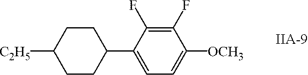 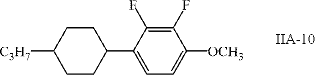 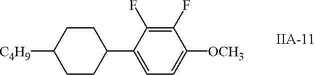 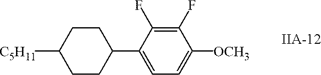 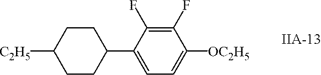 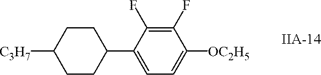 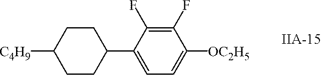 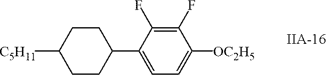 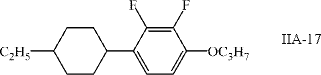 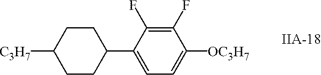 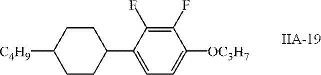 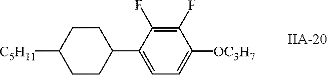 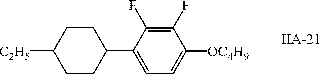 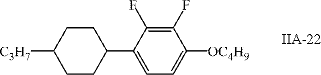 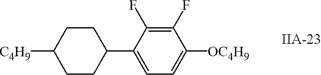 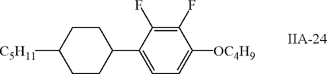 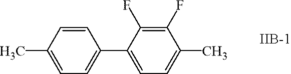 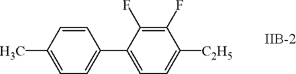 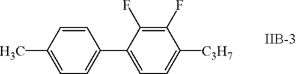 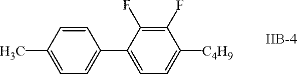 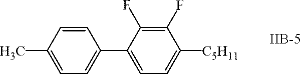 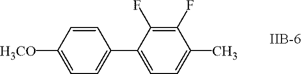 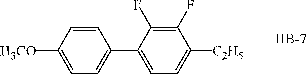 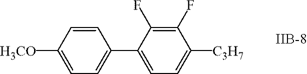 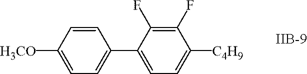 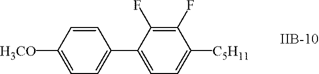 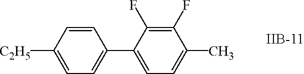 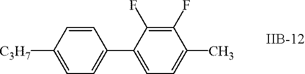 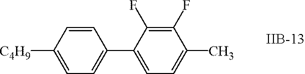 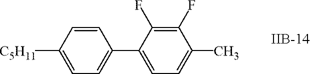 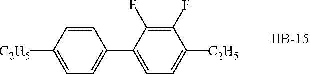 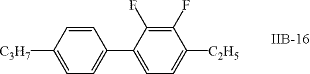 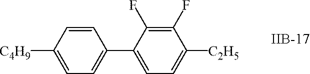 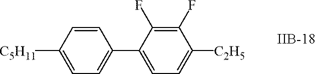 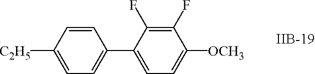 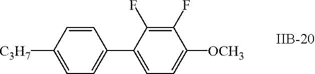 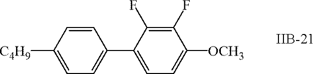 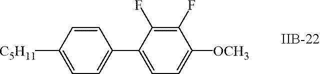 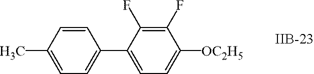 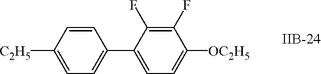 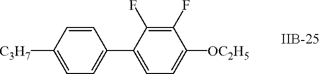 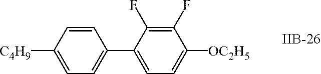 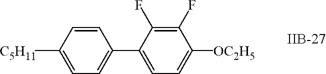 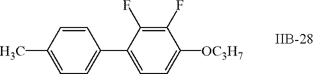 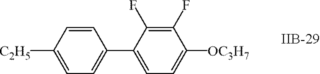 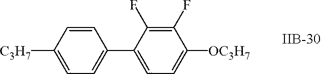 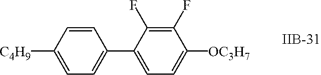 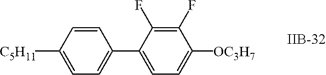 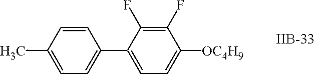 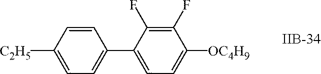 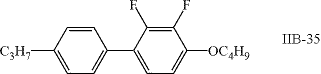 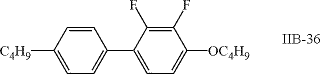 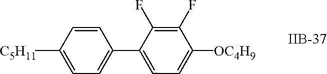 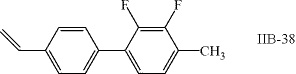 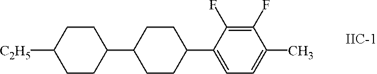 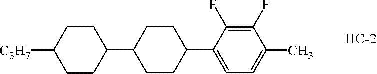 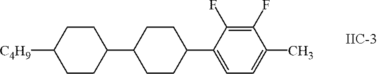 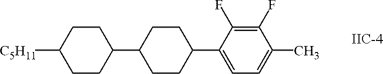 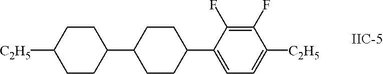 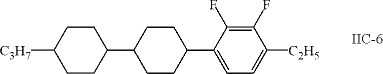 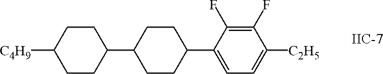 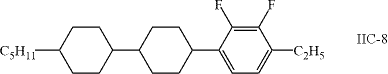 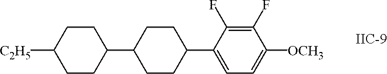 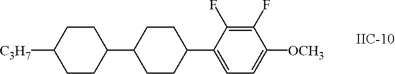 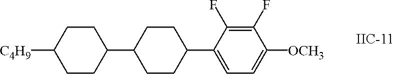 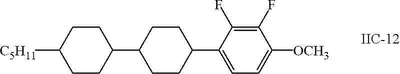 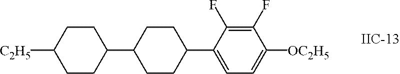 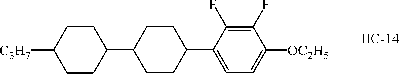 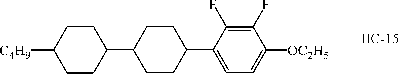 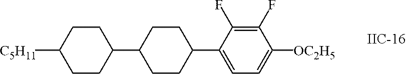 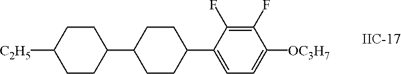 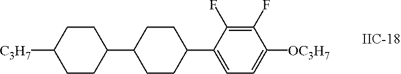 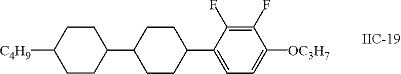 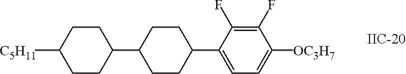 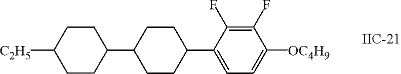 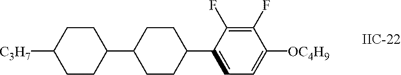 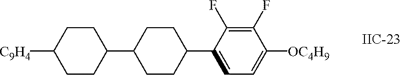 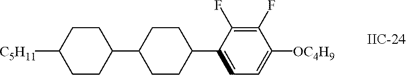 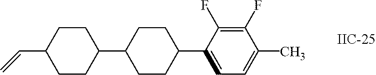 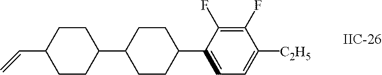 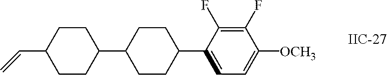 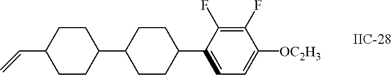 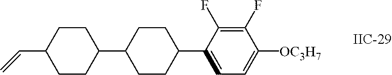 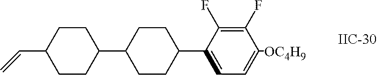 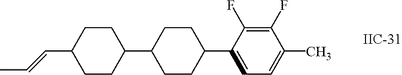 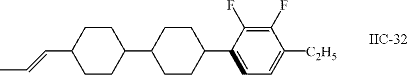 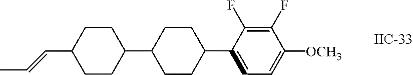 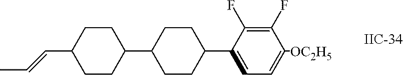 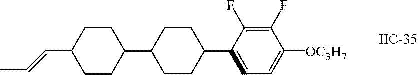 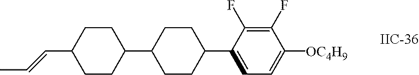 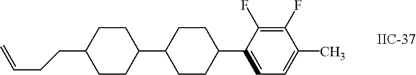 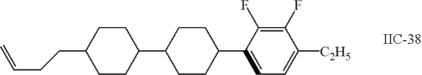 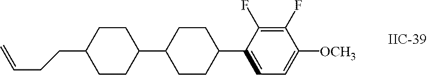 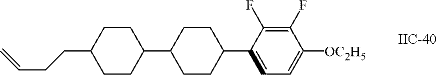 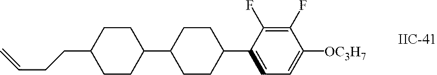 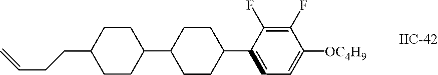 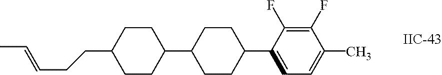 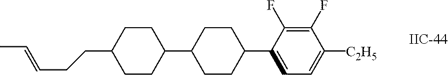 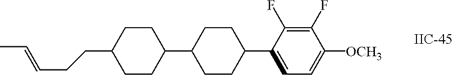 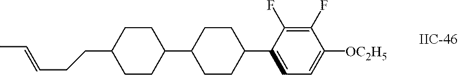 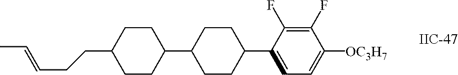 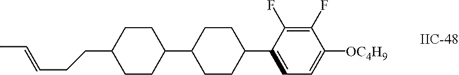 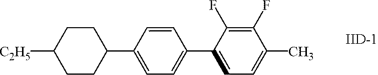 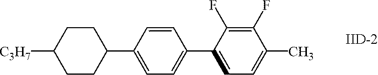 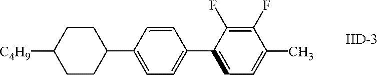 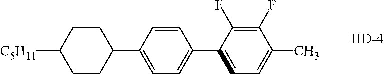 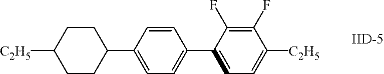 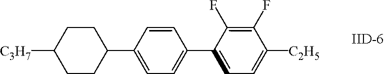 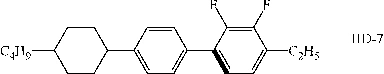 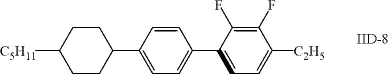 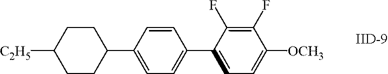 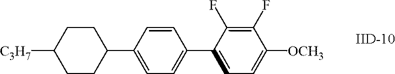 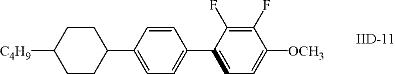 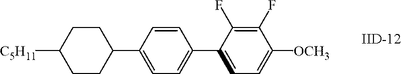 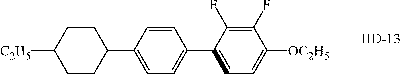 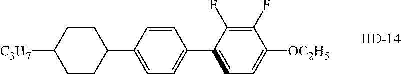 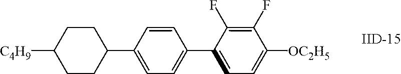 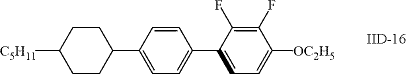 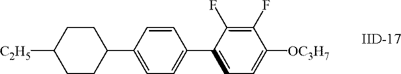 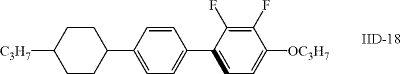 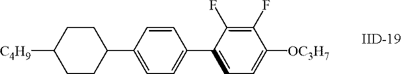 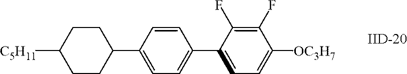 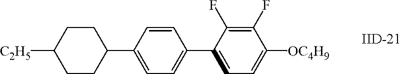 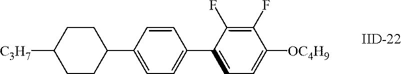 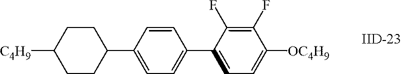 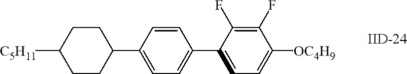 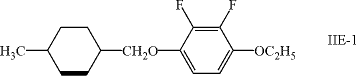 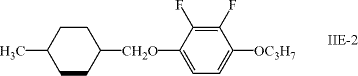 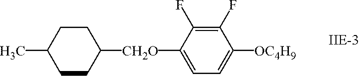 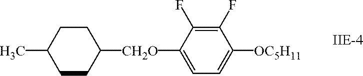 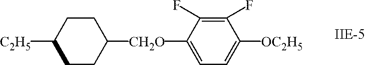 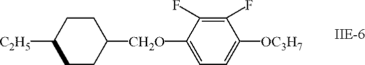 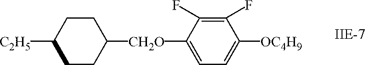 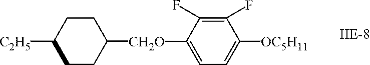 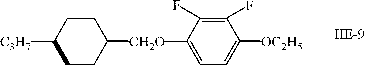 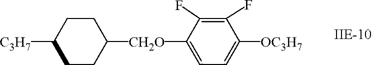 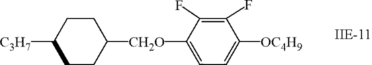 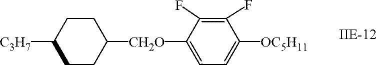 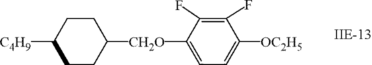 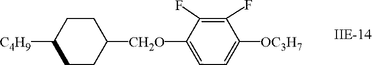 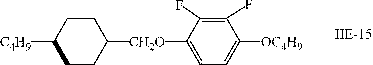 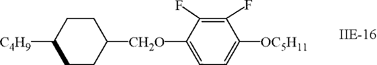 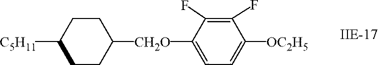 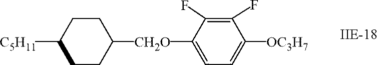 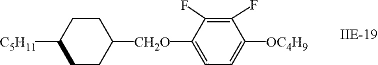 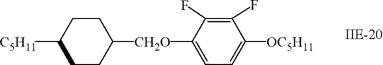 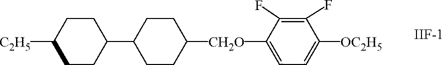 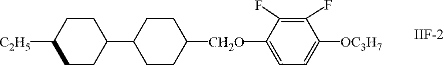 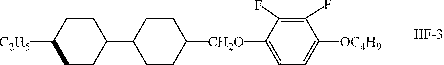 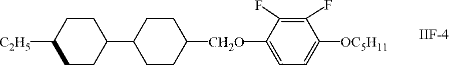 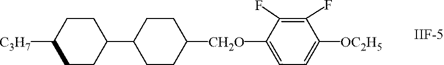 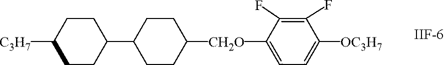 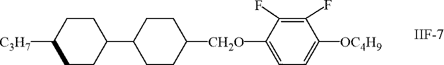 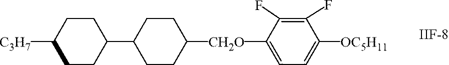 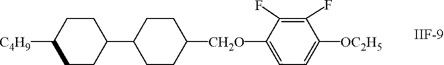 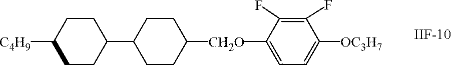 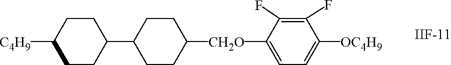 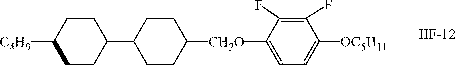 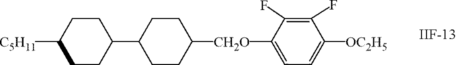 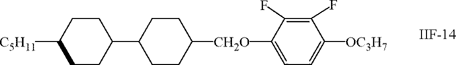 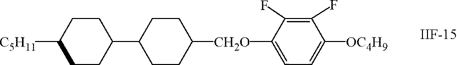 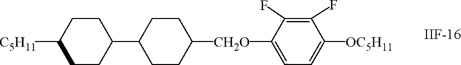
further preferably, the compound represented by general formula II is selected from one or more of formulas IIA-9 - IIA-24, IIB-19 - IIB-38, IIC-9 - IIC-24, IID-9 - IID-24, IIE-1 - IIE-20, and IIF-1 - IIF-16;
most preferably, the compound represented by general formula II is selected from one or more of formulas IIA-13 - IIA-24, IIB-23 - IIB-38, IIC-13 - IIC-24, IID-13 - IID-24, IIE-1, IIE-2, IIE-5, IIE-6, IIE-9, IIE-10, IIE-13, IIE-14, IIE-17, IIE-18, IIF-1, IIF-2, IIF-5, IIF-6, IIF-9, IIF-10, IIF-13 and IIF-14;
and/or the compound represented by general formula III is selected from one or more of formulas IIIA - IIIC: 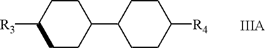 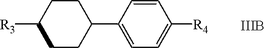 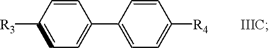
preferably, the compound represented by general formula III is selected from one or more of formulas IIIA1 - IIIC24: 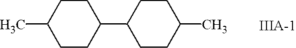 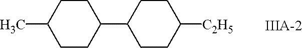 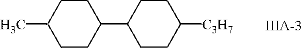 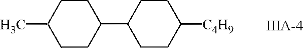 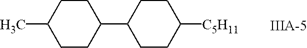 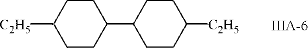 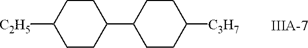 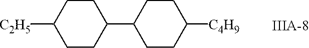 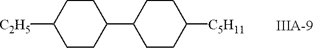 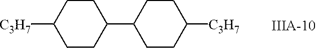 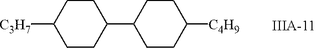 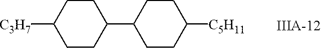 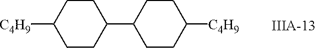 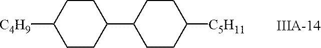 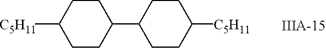 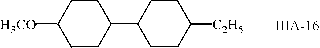 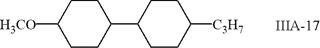 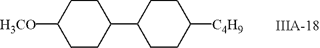 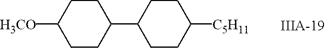 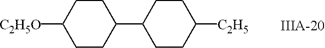 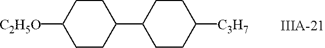 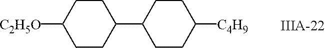 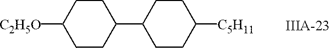 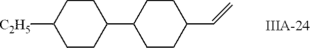 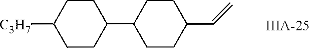 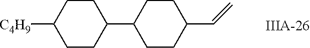 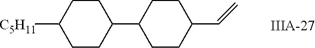 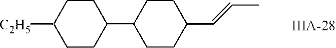 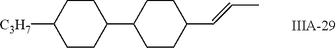 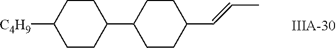 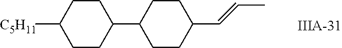 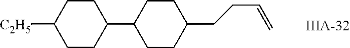 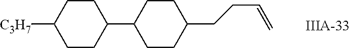 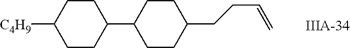 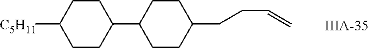 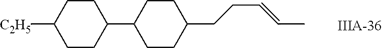 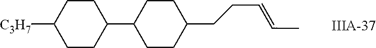 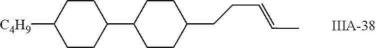 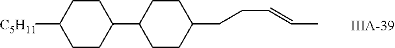 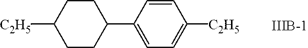 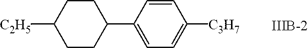 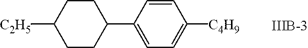 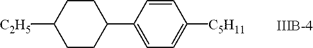 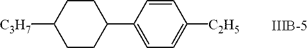 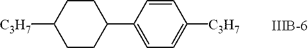 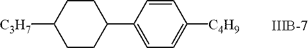 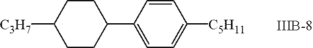 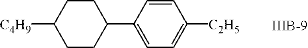 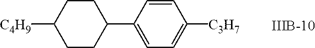 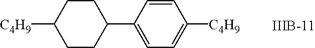 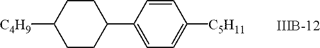 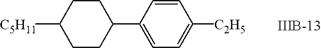 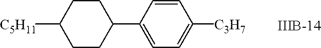 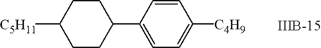 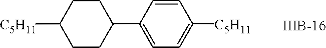 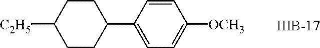 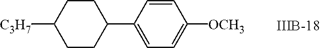 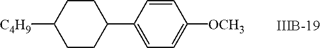 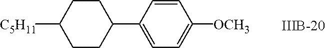 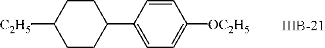 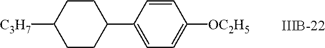 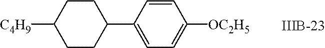 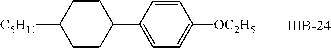 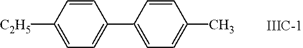 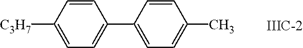 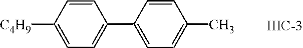 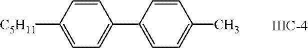 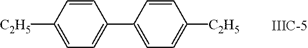 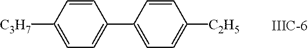 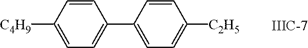 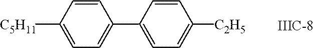 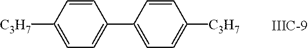 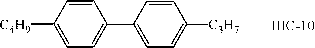 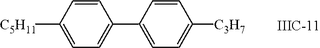 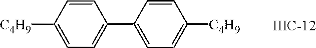 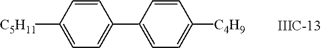 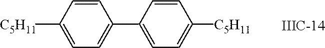 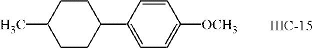 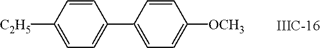 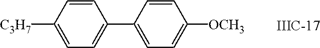 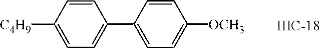 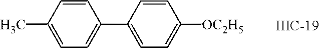 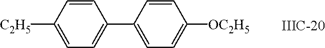 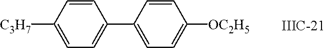 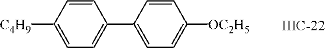 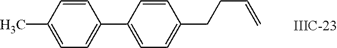 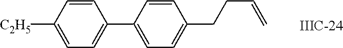
further preferably, the compound represented by general formula III is selected from one or more of formulas IIIA-1 - IIIA-24, IIIB-1 - IIIB-24, and IIIC-1 - IIIC-22;
more preferably, the compound represented by general formula III is selected from one or more of formulas IIIA-1 - IIIA-12, IIIB-17 - IIIB-24, IIIC-1 - IIIC-4, and IIIC-15 - IIIC-18.

8. The liquid crystal composition according to claim 1, wherein the nematic phase liquid crystal composition further comprises one or more compounds represented by general formula IV: 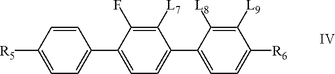
wherein R₅ and R₆ each independently represent a C₁-C₁₂ linear alkyl group, a linear alkoxy group or a C₂-C₁₂ linear alkenyl group, halogen; L7, L8, and L9 each independently represent —H, —F, —CH3 or —OCH3;
preferably, the compound represented by general formula IV is selected from one or more of IVA - IVD: 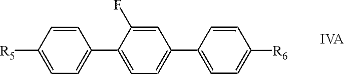 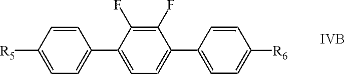 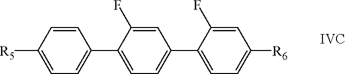 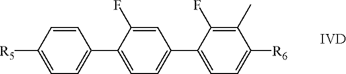
wherein R₅ and R₆ each independently represent a C₁-C₁₂ linear alkyl group, a linear alkoxy group, a C₂-C₁₂ linear alkenyl group or halogen;
further preferably, the compound represented by general formula IV is selected from one or more of IVA1 - IVD24: 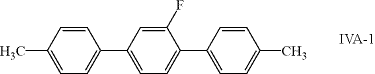 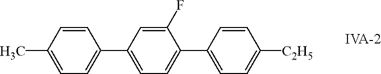 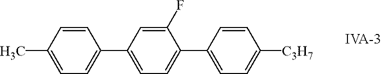 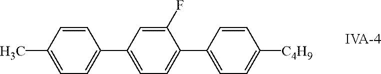 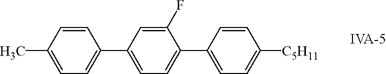 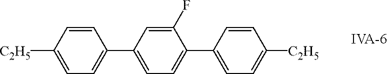 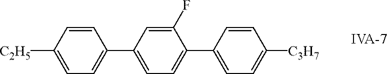 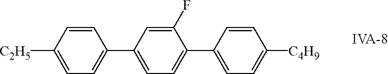 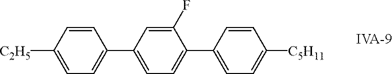 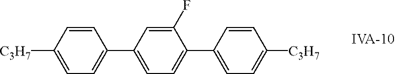 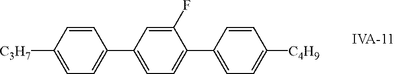 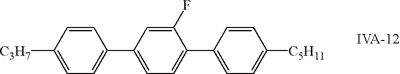 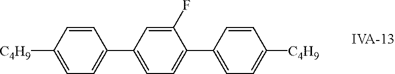 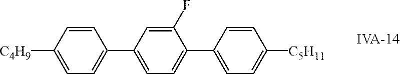 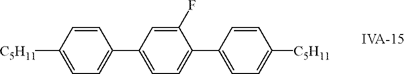 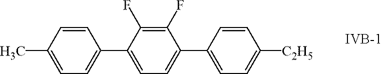 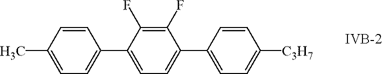 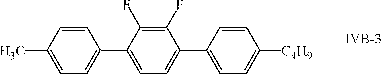 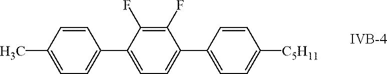 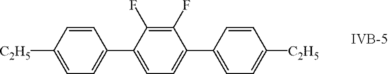 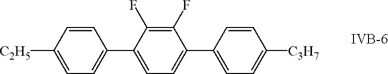 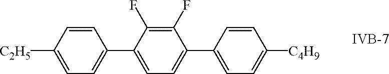 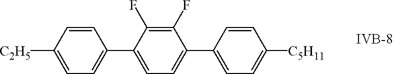 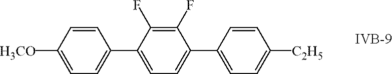 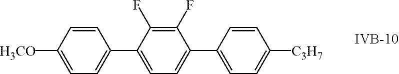 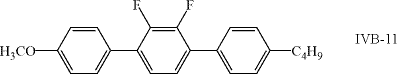 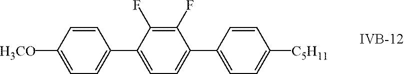 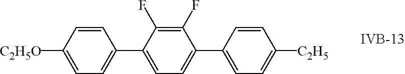 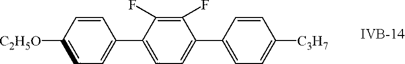 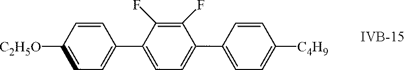 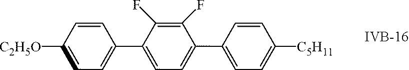 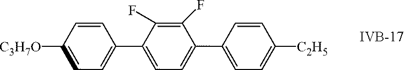 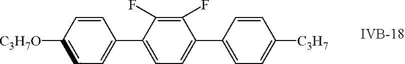 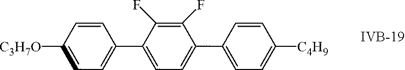 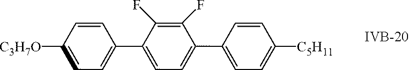 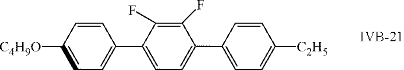 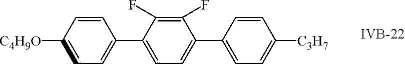 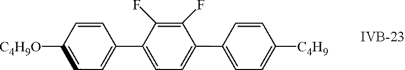 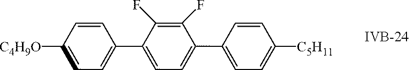 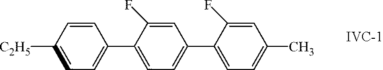 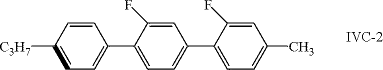 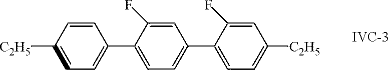 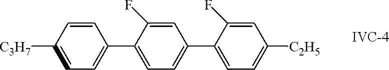 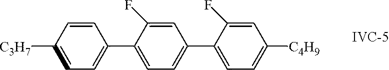 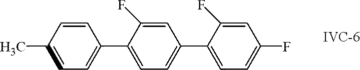 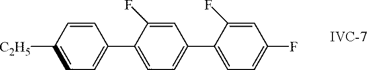 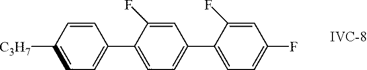 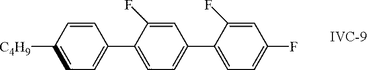 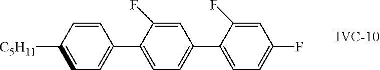 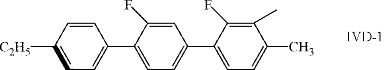 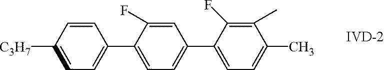 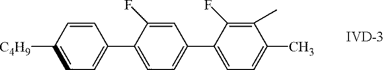 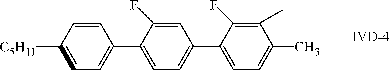 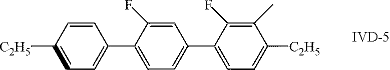 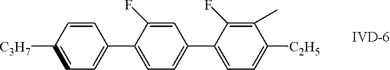 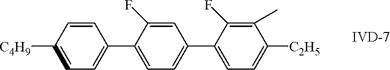 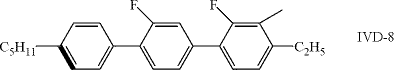 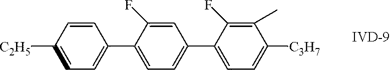 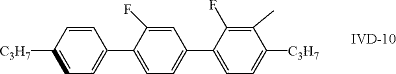 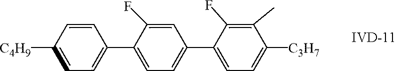 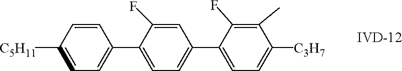 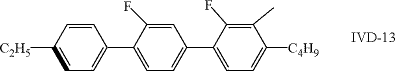 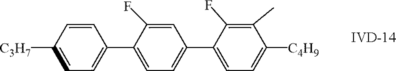 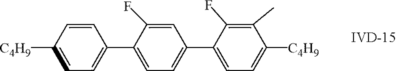 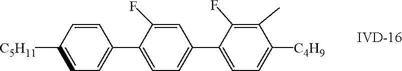 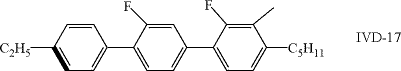 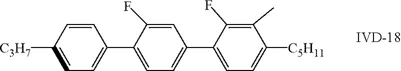 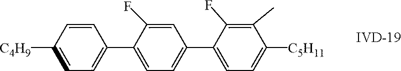 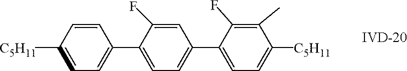 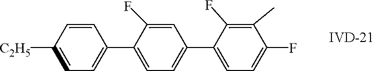 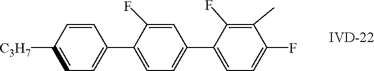 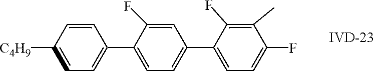 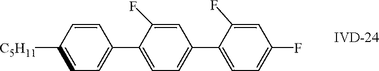
more preferably, the compound represented by general formula IV is selected from one or more of IVA-5, IVA-9, IVA-14, IVA-15, IVB-5 - IVB-8, IVB-6 - IVB-10, and IVD-21 - IVD-24;
and/or the nematic phase liquid crystal composition further comprises one or more compounds represented by general formula V: 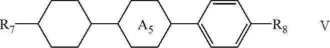
wherein R₇ and R₈ each independently represent a C₁-C₁₂ linear alkyl group, a linear alkoxy group or a C₂-C₁₂ linear alkenyl group; A₅ each independently represents a trans-1,4-cyclohexyl group or a 1,4-phenylene group;
preferably, the compound represented by general formula V is selected from one or more of VA - VB: 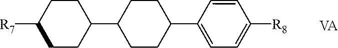 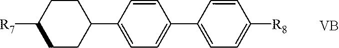
wherein R₇ and R₈ each independently represent a C₁-C₇ linear alkyl group, a linear alkoxy group or a C₂-C₇ linear alkenyl group;
further preferably, the compound represented by general formula V is selected from one or more of VA1 - VB63: 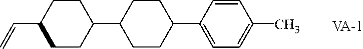 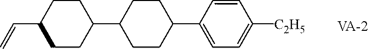 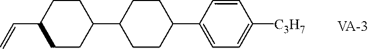 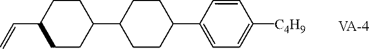 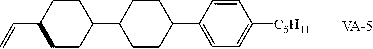 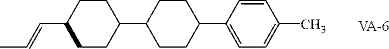 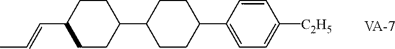 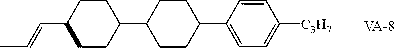 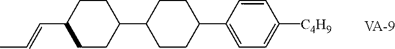 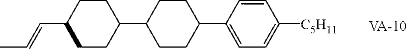 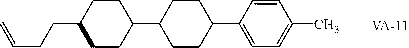 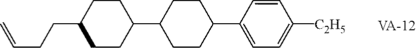 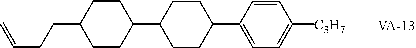 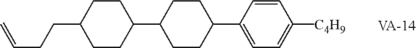 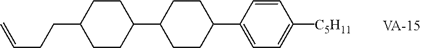 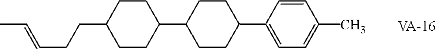 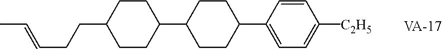 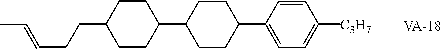 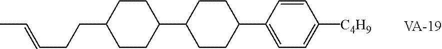 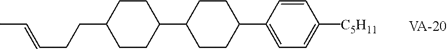 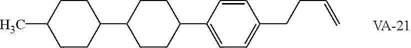 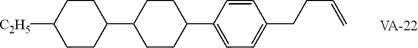 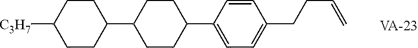 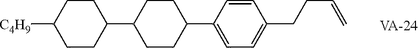 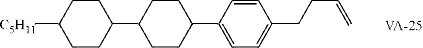 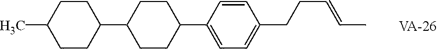 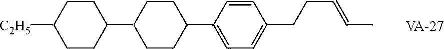 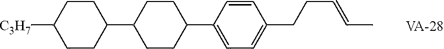 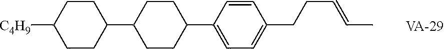 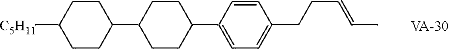 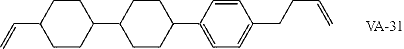 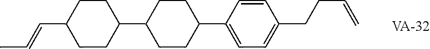 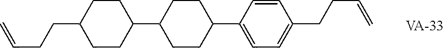 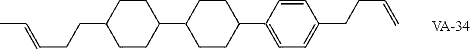 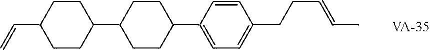 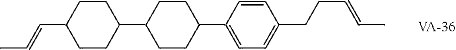 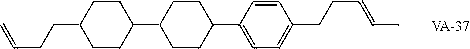 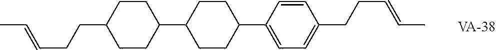 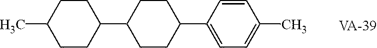 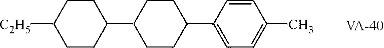 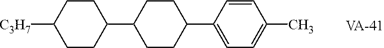 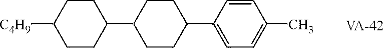 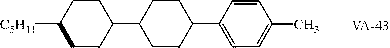 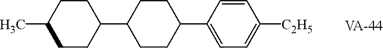 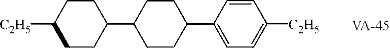 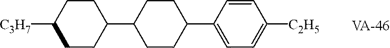 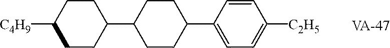 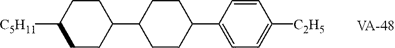 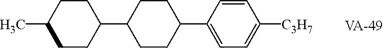 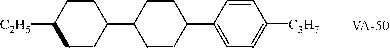 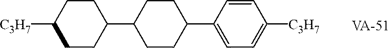 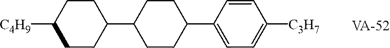 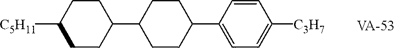 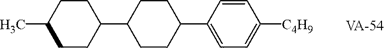 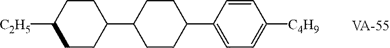 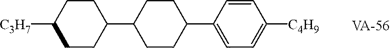 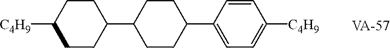 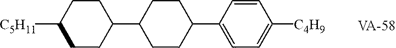 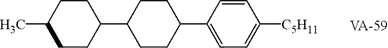 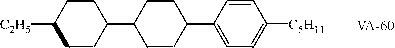 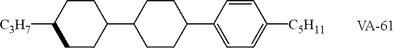 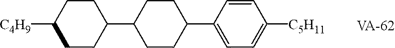 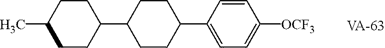 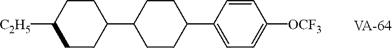 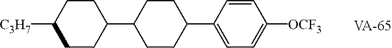 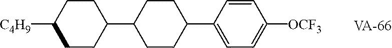 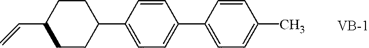 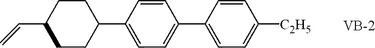 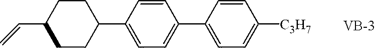 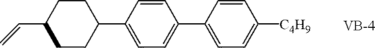 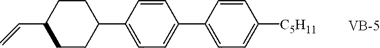 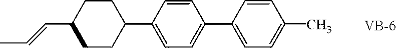 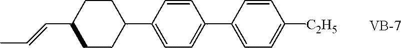 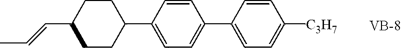 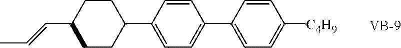 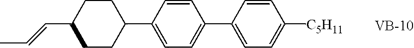 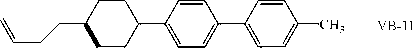 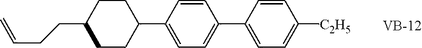 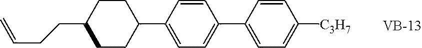 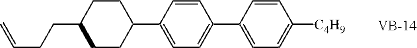 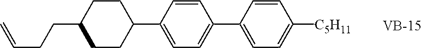 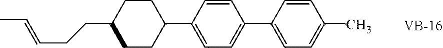 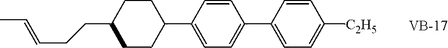 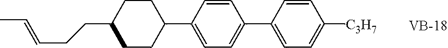 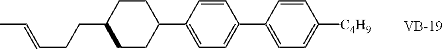 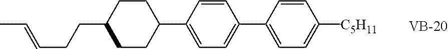 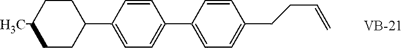 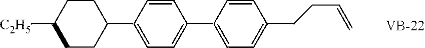 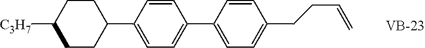 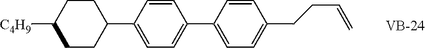 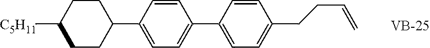 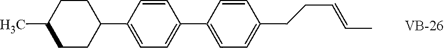 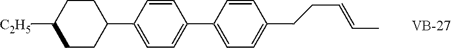 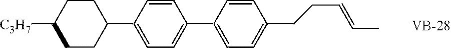 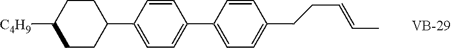 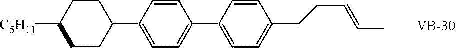 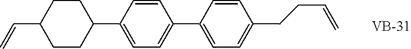 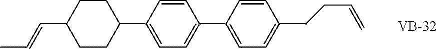 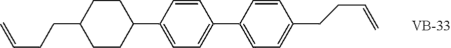 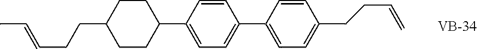 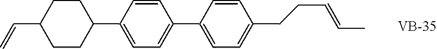 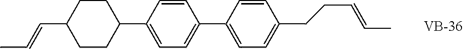 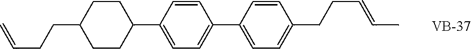 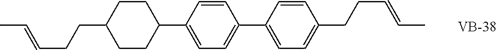 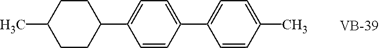 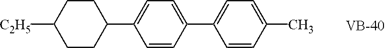 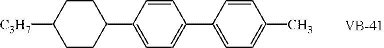 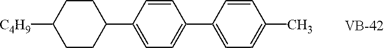 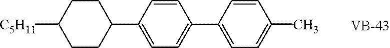 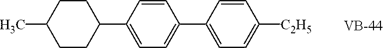 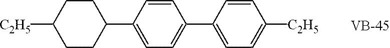 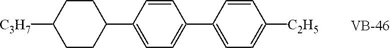 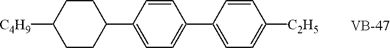 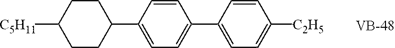 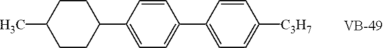 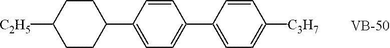 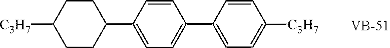 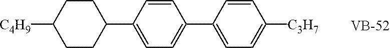 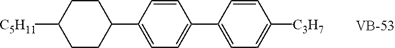 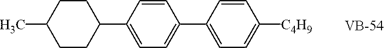 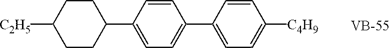 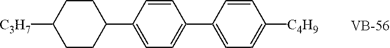 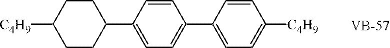 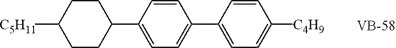 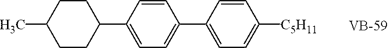 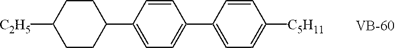 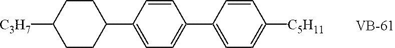 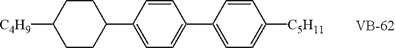 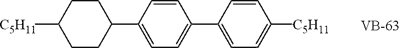
more preferably, the compound represented by general formula V is selected from one or more of VA-39 - VA-44, and VB-39 - VB-48;
and/or the liquid crystal composition further comprises one or more antioxidants represented by general formula VI: 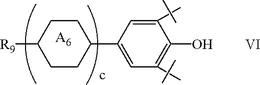
wherein R₉ each independently represents a C₁-C₇ linear alkyl group, a linear alkoxy group or a C₂-C₇ linear alkenyl group; A₆ each independently represents a trans-1,4-cyclohexyl group or a 1,4-phenylene group, and c is 0 or 1;
preferably, the compound represented by the general formula VI is selected from one or more of VI-1 - VI-2:

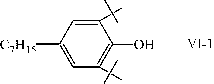

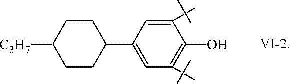

9. The liquid crystal composition according to claim 1, wherein the nematic phase liquid crystal composition comprises the following components by mass percentage:
(1) 1-80% of the compound represented by general formula II;
(2) 1-70% of the compound represented by general formula III;
(3) 0-25% of the compound represented by general formula IV;
and (4) 0-25% of the compound represented by general formula V;
preferably, the liquid crystal compound comprises the following components by mass percentage:
(1) 5-70% of the compound represented by general formula II;
(2) 20-60% of the compound represented by general formula III;
(3) 0-15% of the compound represented by general formula IV;
and (4) 0-15% of the compound represented by general formula V;
more preferably, the liquid crystal compound comprises the following components by mass percentage:
(1) 10-70% of the compound represented by general formula II;
(2) 25-60% of the compound represented by general formula III;
(3) 0-10% of the compound represented by general formula IV;
and (4) 0-10% of the compound represented by general formula V;
particularly preferably, the liquid crystal compound comprises the following components by mass percentage:
(1) 20-70% of the compound represented by general formula II;
(2) 20-50% of the compound represented by general formula III;
(3) 0-6% of the compound represented by general formula IV;
and (4) 0-9% of the compound represented by general formula V.

10. Use of the liquid crystal composition according to claim 1, in a VA-type liquid crystal display device, preferably in a PSVA-type liquid crystal display device.
